(19) United States
(12) Patent Application Publication
(10) Pub. No.: US 2026/0219431 A1
(43) Pub. Date: Jul. 30, 2026

(54) OPTICAL MODULE AND PROJECTOR

(71) Applicant: SEIKO EPSON CORPORATION, Tokyo (JP)

(72) Inventors: Takuo YONEYAMA, AZUMINO-SHI (JP); Masashi KATO, AZUMINO-SHI (JP)

(21) Appl. No.: 19/460,485

(22) Filed: Jan. 27, 2026

(30) Foreign Application Priority Data
Jan. 28, 2025 (JP) 2025-011986

(51) Int. Cl. G02B 5/30; G03B 21/14; G03B 21/20; G03B 41/08

(52) U.S. Cl. CPC G02B 5/3083; G03B 21/145; G03B 21/2073; G03B 41/08; G03B 2205/0053

(57) ABSTRACT

An optical module according to an aspect of the present disclosure includes: a light source apparatus configured to output light; an image generation apparatus configured to generate image light from the light output from the light source apparatus based on image information; and a projection system configured to project light output from the image generation apparatus. The image generation apparatus includes an image generator configured to generate the image light from the light output from the light source apparatus, and a retarder configured to temporally change a phase difference of the image light output from the image generator.

The present application is based on, and claims priority from JP Application Serial Number 2025-011986, filed January 28, 2025, the disclosure of which is hereby incorporated by reference herein in its entirety.

### BACKGROUND

### 1. Technical Field

The present disclosure relates to an optical module and a projector.

### 2. Related Art

In an image display apparatus such as a projector, a laser is used in some cases as a light emitter to increase luminance and performance. For example, JP-A-2019-061110 discloses a liquid crystal projector including an illuminator including semiconductor lasers (laser diodes: LDs). The illuminator of the liquid crystal projector disclosed in JP-A-2019-061110 includes a light source unit including a blue LD, a green LD, and a red LD. In the illuminator disclosed in JP-A-2019-061110, the multiple types of color light output from the light source unit are radiated to a diffuser plate disposed at a predetermined light collection position and being rotatable with the aid of a motor, and is diffused at a surface of the diffuser plate that intersects with the optical axis.

JP-A-2019-061110 is an example of the related art.

In the illuminator disclosed in JP-A-2019-061110 described above, the luminous flux width of the blue light collected at the predetermined position on the plate surface of the diffuser plate is smaller than the luminous flux widths of the green light and the red light collected at the same position, and the distribution of the angle of incidence of the blue light incident on the diffuser plate is narrower than the distributions of the angles of incidence of the green light and the red light incident on the diffuser plate. Therefore, even when the angle of incidence and the distribution of the angle of incidence of the blue light are smaller than those of the green light and the red light, the distributions of the diffusion angle of the multiple types of color light can be equally increased, so that an effect of suppressing speckle noise is provided. An observer may, however, visually recognize speckle noise due to shape errors or performance differences in the direction of rotation or movement of the diffuser plate, so that further reduction in the speckles is required.

### SUMMARY

An optical module according to an aspect of the present disclosure includes: a light source apparatus configured to output light; an image generation apparatus configured to generate image light from the light output from the light source apparatus based on image information; and a projection system configured to project light output from the image generation apparatus. The image generation apparatus includes an image generator configured to generate the image light from the light output from the light source apparatus, and a retarder configured to temporally change a phase difference of the image light output from the image generator.

### BRIEF DESCRIPTION OF THE DRAWINGS

FIG. 1 is a schematic view of a projector and an optical module according to a first embodiment of the present disclosure.

FIG. 2 is a schematic view of a retardation film provided in the projector shown in FIG. 1.

FIG. 3 is a diagrammatic view showing a trajectory representing that the polarization state of image light incident on the retardation film in the projector shown in FIG. 1 changes when the retardation film rotates.

FIG. 4 is a schematic view of a projector and an optical module according to a variation of the first embodiment of the present disclosure.

FIG. 5 is a schematic view of a projector and an optical module according to a second embodiment of the present disclosure.

FIG. 6 shows graphs illustrating the wavelength dependence of a phase difference imparted to image light incident on a retardation film of the projector shown in FIG. 5 rotates and vibrates.

FIG. 7 is a schematic view of a projector and an optical module according to a variation of the second embodiment of the present disclosure.

### DESCRIPTION OF EMBODIMENTS

Embodiments of the present disclosure will be described below with reference to the drawings. In the drawings, elements are each drawn at a dimensional scale changed from the actual value in some cases for clarity of the element.

### First embodiment

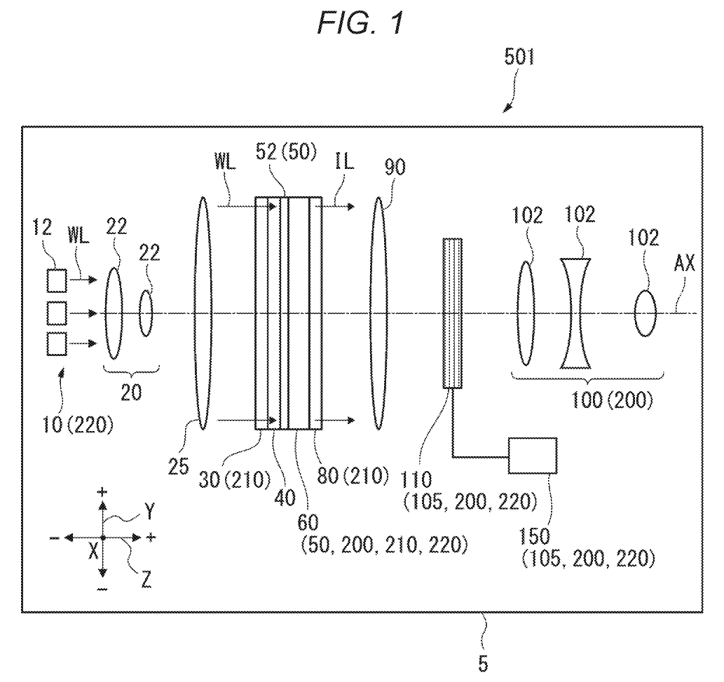

A first embodiment of the present disclosure will first be described with reference to FIGS. 1 to 3. FIG. 1 is a schematic view showing the configuration of a projector 501 according to the first embodiment. The projector 501 is a projection-type image display apparatus including one liquid crystal panel as a light modulator, and is what is called a single-plate projector.

The projector 501 includes a light source apparatus 10, a pickup optical system 20, a parallelizing lens 25, a light-incident-side polarizer 30, a lens array 40, a light modulator 50, a light-exiting-side polarizer 80, a light collection lens 90, a retarder 105, and a projection system 100, as shown in FIG. 1. The light source apparatus 10, the pickup optical system 20, the parallelizing lens 25, the light-incident-side polarizer 30, the lens array 40, the light modulator 50, the light-exiting-side polarizer 80, the light collection lens 90, the retarder 105, and the projection system 100 are disposed in the internal space of an exterior body 5.

The light source apparatus 10 includes light emitters 12 and outputs white light WL containing red light, green light, and blue light, as shown in FIG. 1. The white light WL corresponds to light that will be described later, and corresponds to the light described in the claims and the light output from the light source apparatus.

The light emitters 12 are provided at one plate surface of a substrate that is not shown. A light emission surface of each of the light emitters 12 is opposite a surface of the light emitter 12 that is the surface facing the one plate surface of the substrate. The light source apparatus 10 outputs the white light WL along an optical axis parallel to an axis perpendicular to the one plate surface of the substrate. The shape of the light emission surface of each of the light emitters 12 in a plan view, that is, the shape viewed along the optical axis is, for example, a rectangular shape.

The light emitters 12 are each, for example, a white LD. The white LD includes, for example, a blue LD and a phosphor that is excited by blue light emitted from the blue LD to emit yellow light. The phosphor is, for example, a ceramic phosphor made of an yttrium-aluminum-garnet-based (YAG-based) material to which cerium (Ce) is added as an activator. When the light source apparatus 10 includes multiple light emitters 12 as shown in FIG. 1 by way of example, the multiple light emitters 12 are arranged in a matrix at appropriate intervals at the one plate surface of the substrate, and the entire region occupied by the light emission surfaces of the multiple light emitters 12 at the one plate surface of the substrate acts as the light emission surface via which the white light WL is emitted.

When the light source apparatus 10 includes multiple light emitters 12, the light emitters 12 may each, for example, be any of the red LD, the green LD, and the blue LD. In this case, the numbers of red LDs, green LDs, and blue LDs arranged at the one plate surface of the substrate are appropriately determined in accordance with the luminance or illuminance of the color light emitted from each of the LDs and the color balance required for the white light WL.

In the following description and drawings, an axis parallel to an optical axis AX of the white light WL output from the light source apparatus 10 is referred to as a Z-axis. One side of the Z-axis is called a −Z side, and the other side of the Z-axis is called a +Z side. One axis perpendicular to the Z-axis is called an X-axis. One side of the X-axis is called a −X side, and the other side of the X-axis is called a +X side. An axis perpendicular to the X-axis and the Z-axis is called a Y-axis. One side of the Y-axis is called a −Y side, and the other side of the Y-axis is called a +Y side. FIG. 1 corresponds to a side view of the projector 501 viewed from the +X side along the X-axis. The white light WL is output from the light source apparatus 10 toward the +Z side along the optical axis AX and the Z-axis.

The pickup optical system 20 is disposed on the +Z side of the light source apparatus 10 and is disposed in the optical path of the white light WL output from the light source apparatus 10. The pickup optical system 20 appropriately changes and enlarges the in-XY-plane beam diameter of the white light WL incident from the −Z side, and outputs the white light WL having a desired beam diameter toward the +Z side along the Z-axis.

The pickup optical system 20 includes, for example, one or more optical lenses 22. The center of each of the optical lenses 22 in a plane containing the X-axis and the Y-axis is located on the optical axis AX and the Z-axis. The dimension, shape, and curvature of each of the light incident surface and the light exiting surface of each of the optical lenses 22 in the plane containing the X-axis and the Y-axis are designed as appropriate in accordance with the radiation characteristics of the white light WL that enters the pickup optical system 20, the angular distribution and the illuminance distribution of the white light WL around the optical axis AX, and other factors. The optical lenses 22 are each, for example, any refractive lens such as a biconvex lens, a plano-convex lens, a biconcave lens, a plano-concave lens, a meniscus lens, a free-form surface lens, and an aspherical lens, or a cemented lens that is a combination of the refractive lenses described above.

The parallelizing lens 25 is disposed on the +Z side of the pickup optical system 20 and is disposed in the optical path of the white light WL output from the pickup optical system 20. The dimension, shape, and curvature of the parallelizing lens 25 in a plane containing the X-axis and the Y-axis are designed as appropriate in accordance with the distance between the light-exiting-side end of the pickup optical system 20 and the center of the parallelizing lens 25 along the Z-axis, the angular distribution and the illuminance distribution around the optical axis AX of the white light WL output from the pickup optical system 20, the dimensions of a modulation region of the light modulator 50, which will next be described, in a plane containing the X-axis and the Y-axis, and other factors.

The parallelizing lens 25 parallelizes the white light WL incident from the −Z side along the Z-axis. The parallelizing lens 25 is configured, for example, with a refractive lens such as a plano-convex lens or a biconvex lens, or a diffraction lens such as a Fresnel lens.

A beam region of the white light WL output from the parallelizing lens 25 in the plane containing the X-axis and the Y-axis contains the modulation region of the light modulator 50 in the plane containing the X-axis and the Y-axis. The modulation region of the light modulator 50 means a region where multiple pixels of the light modulator 50 that are not shown are arranged along the X-axis and the Y-axis. Based on the configuration described above, the parallelizing lens 25 has a diameter corresponding to a dimension to which an appropriate margin is added to the maximum dimension, in the plane containing the X-axis and the Y-axis, of the modulation region of the light modulator 50 provided in the single-plate projector 501. A Fresnel lens is, for example, used as the parallelizing lens 25 to appropriately suppress the thickness of the parallelizing lens 25 along the Z-axis.

A diffuser plate that is not shown may be disposed as necessary between the pickup optical system 20 and the parallelizing lens 25 in the optical path of the white light WL. The thus disposed diffuser plate improves the illuminance distribution and the degree of color mixture of the white light WL in a plane perpendicular to the optical axis AX and the Z-axis.

The light-incident-side polarizer 30 is disposed on the +Z side of the parallelizing lens 25, and is disposed in the optical path of the white light WL output from the parallelizing lens 25. The center of the light-incident-side polarizer 30 in a plane containing the X-axis and the Y-axis is located on the optical axis AX and the Z-axis. The white light WL output from the parallelizing lens 25 and incident on the light-incident-side polarizer 30 from the −Z side travels along the optical axis AX and the Z-axis and is not deflected. The light-incident-side polarizer 30 is disposed within a range where the light-incident-side polarizer 30 overlaps with the parallelizing lens 25 in the plane containing the X-axis and the Y-axis.

The light-incident-side polarizer 30 outputs predetermined polarized light out of the incident white light WL. The predetermined polarized light is, for example, P-polarized light or S-polarized light. The light-incident-side polarizer 30 is, for example, an absorptive or reflective polarizer having sensitivity to a visible wavelength band. The light-incident-side polarizer 30, when it is an absorptive polarizer, suppresses stray light generated when the white light WL other than the predetermined polarized light out of the white light WL incident on the light-incident-side polarizer 30 is reflected off the light-incident-side polarizer 30 toward the −Z side.

The lens array 40 is disposed on the +Z side of the light-incident-side polarizer 30, and is disposed in the optical path of the white light WL output from the light-incident-side polarizer 30. The white light WL output from the light-incident-side polarizer 30 and incident on the lens array 40 from the −Z side travels along the optical axis AX and the Z-axis and is not deflected. The lens array 40 is disposed within a range where the lens array 40 overlaps with the light-incident-side polarizer 30 in a plane containing the X-axis and the Y-axis.

The lens array 40 divides the incident white light WL into multiple minute regions in the plane containing the X-axis and the Y-axis, and collects the white light WL in each of the minute regions. The lens array 40 includes multiple microlenses that are not shown but are provided in the multiple minute regions. The multiple microlenses are arranged along the X-axis and the Y-axis. The light incident surface of the lens array 40 is configured with the −Z-side -light incident surfaces of the multiple microlenses. The light exiting surface of the lens array 40 is configured with the +Z-side light exiting surfaces of the multiple microlenses.

Each of the microlenses of the lens array 40 is, for example, a plano-convex lens, and may instead be an optical lens such as a biconvex lens other than a plano-convex lens in accordance with the distance to the light modulator 50 adjacent to the lens array 40 on the +Z side. When the light exiting surface, that is, the +Z-side end surface of the lens array 40 is in contact with the light incident surface, that is, the −Z-side end surface of the light modulator 50, the microlenses are each preferably a plano-convex lens having a light incident surface configured with a curved surface convex toward the −Z side and a light exit surface configured with a planar surface parallel to the plane containing the X-axis and the Y-axis.

The light modulator 50 is disposed on the +Z side of the lens array 40 and is disposed in the optical path of the white light WL output from the lens array 40. The light modulator 50 is disposed, for example, at a distance from the lens array 40 along the Z-axis, and may instead be in contact with the lens array 40 on the −Z side as described above. The white light WL output from the lens array 40 and incident on the light modulator 50 from the −Z side travels along the optical axis AX and the Z-axis and is not deflected. The light modulator 50 is disposed within a range containing the lens array 40 in a plane containing the X-axis and the Y-axis.

The light modulator 50 modulates the incident white light WL in accordance with electric signals according to image information input from an image output apparatus such as a computer or a tablet terminal that is not shown but is provided outside the projector 501 to generate full-color image light IL.

The light modulator 50 is configured with a color filter 52 and a liquid crystal element 60 including pixel electrodes that are not shown. The color filter 52 is formed in a plate shape. The center of the color filter 52 in a plane containing the X-axis and the Y-axis and the center of the liquid crystal element 60 in the plane containing the X-axis and the Y-axis are located on the optical axis AX. The light incident surface and the light exiting surface of the color filter 52 are parallel to the plane containing the X-axis and the Y-axis. The light incident surface of the color filter 52 faces the light exiting surface of the lens array 40.

The color filter 52 includes multiple blue filters, multiple green filters, and multiple red filters none of which are shown. The blue filters transmit blue light out of the incident white light WL. The green filters transmit green light out of the incident white light WL. The red filters transmit red light out of the incident white light WL.

The liquid crystal element 60 is disposed on the +Z side of the color filter 52, is thicker than the color filter 52, and is formed in a substantially plate shape. The −Z-side light incidence surface and the +Z-side light exiting surface of the liquid crystal element 60 are parallel to the plane containing the X-axis and the Y-axis. The light incident surface of the liquid crystal element 60 is in contact with the light exiting surface of the color filter 52. The liquid crystal element 60 includes the multiple pixels in the light modulator 50. The multiple pixels are arranged in a matrix along the X-axis and the Y-axis. The multiple pixels include blue pixel electrodes, green pixel electrodes, and red pixel electrodes.

When viewed along the optical axis AX and the Z-axis, the blue filters, the green filters, and the red filters of the color filter 52 overlap with the microlenses of the lens array 40. The blue pixel electrodes of the multiple pixels of the liquid crystal element 60 are disposed so as to correspond to the blue filters of the color filter 52. The green pixel electrodes of the multiple pixels of the liquid crystal element 60 are disposed so as to correspond to the green filters of the color filter 52. The red pixel electrodes of the multiple pixels of the liquid crystal element 60 are disposed so as to correspond to the red filters of the color filter 52.

The image output apparatus described above, which is not shown, is electrically coupled to pixel electrodes formed in correspondence with the multiple pixels of the liquid crystal element 60. Electric signals to be supplied from the image output apparatus to the pixel electrodes for the multiple pixels of the liquid crystal element 60 are generated in accordance with image information on a projection target, are converted into electric signals according to the amount of modulation to be performed on the multiple types of color light to be modulated by the blue pixel electrodes, the green pixel electrodes, and the red pixel electrodes of the pixels by a circuit, wiring, and the like none of which is shown but are provided in the pixel electrodes, and are supplied to the pixel electrodes of the multiple colors.

The blue pixel electrodes, the green pixel electrodes, and the red pixel electrodes each include a switching element configured, for example, with a polysilicon thin film transistor (TFT). The blue pixel electrodes change the polarization direction of the blue light passing through the blue filters with the aid of the operation of the switching elements according to the corresponding electric signal input from the image output apparatus.

The blue pixel electrodes modulate the incident blue light and output blue image light. The green pixel electrodes change the polarization direction of the green light passing through the green filters with the aid of the operation of the switching elements according to the corresponding electric signal input from the image output apparatus. The green pixel electrodes modulate the incident green light and output green image light. The red pixel electrodes change the polarization direction of the red light passing through the red filters with the aid of the operation of the switching elements according to the corresponding electric signal input from the image output apparatus. The red pixel electrodes modulate the incident red light and output red image light.

The blue image light output from the blue pixel electrodes out of the pixel electrodes, the green image light output from the green pixel electrodes out of the pixel electrodes, and the red image light output from the red pixel electrodes out of the pixel electrodes are combined with one another on a pixel basis to generate the full-color image light.

The light-exiting-side polarizer 80 is disposed on the +Z side of the light modulator 50, and is disposed in the optical path of the full-color image light IL output from the light modulator 50. The light incident surface of the light-exiting-side polarizer 80 is in contact with the light exiting surface of the liquid crystal element 60 of the light modulator 50, and may instead be separate from the light exiting surface of the liquid crystal element 60 along the Z-axis. The light-exiting-side polarizer 80 is disposed within a range where the light-exiting-side polarizer 80 substantially overlaps with the light-incident-side polarizer 30 and the light modulator 50 in a plane containing the X-axis and the Y-axis.

The light-exiting-side polarizer 80 outputs predetermined polarized light out of the full-color image light IL incident from the light modulator 50. The light-exiting-side polarizer 80 is, for example, an absorptive or reflective polarizer having sensitivity to the visible wavelength band. The light-exiting-side polarizer 80, when it is an absorptive polarizer, suppresses stray light and light returning to the light modulator 50 that are both generated when the white light WL other than the predetermined polarized light out of the image light IL incident on the light-exiting-side polarizer 80 is reflected off the light-exiting-side polarizer 80 toward the −Z side.

The light collection lens 90 is disposed on the +Z side of the light-exiting-side polarizer 80, and is disposed in the optical path of the image light IL output from the light-exiting-side polarizer 80. The dimension, shape, and curvature of the light collection lens 90 in a plane containing the X-axis and the Y-axis are designed as appropriate in accordance with the distance between the light-exiting-side end of the light modulator 50 and the center of the light collection lens 90 along the Z-axis, the angular distribution and the illuminance distribution around the optical axis AX of the white light WL output from the light-exiting-side polarizer 80, the dimensions of the projection system 100, which will next be described, in a plane containing the X-axis and the Y-axis, the power of the projection system 100, and other factors.

The white light WL output from the light-exiting-side polarizer 80 and incident on the light collection lens 90 from the −Z side travels along the optical axis AX and the Z-axis and is not deflected. The light collection lens 90 is disposed within a range containing the modulation region of the light modulator 50, where the multiple pixels are arranged, in the plane containing the X-axis and the Y-axis, and within a range where the light collection lens 90 overlaps with the light-exiting-side polarizer 80.

The liquid crystal element 60 is provided in an image generator that will be described later, and is provided in the image generator described in the claims. For example, the light-incident-side polarizer 30, the liquid crystal element 60, and the light-exiting-side polarizer 80 constitute an image generator 210 in the projector 501.

The light collection lens 90 collects the image light IL incident from the −Z side and directs the collected image light IL toward a predetermined position on the +Z side of the light collection lens 90. The light collection lens 90 is configured, for example, with a refractive lens such as a plano-convex lens or a biconvex lens, or a diffraction lens such as a Fresnel lens. A Fresnel lens is, for example, used as the light collection lens 90 to appropriately suppress the thickness of the light collection lens 90 along the Z-axis.

The retarder 105 includes a retardation film 110 and a rotator 150. The retardation film 110 is disposed on the +Z side of at least the light-exiting-side polarizer 80, and is disposed in the optical path of the image light IL output from the light-exiting-side polarizer 80, for example, is disposed on the +Z side of the light collection lens 90. Note that the retardation film 110 may be disposed on the −Z side of the light collection lens 90, and may be disposed between the light-exiting-side polarizer 80 and the light collection lens 90 along the Z-axis. The center of the retardation film 110 in a plane containing the X-axis and the Y-axis is located on the optical axis AX and the Z-axis.

The retarder 105, in which the retardation film 110 rotates around a center axis CX, temporally changes a phase difference to be imparted to the image light IL to temporally change the phase difference of the image light IL output from the liquid crystal element 60. Specifically, the polarization state of the image light IL incident on the retardation film 110 from the −Z side is substantially maintained at the polarization state of the predetermined polarized light by the light-exiting-side polarizer 80. The retardation film 110 is an optical element having plate surfaces parallel to the plane containing the X-axis and the Y-axis and formed, for example, in a plate shape. The retardation film 110 increases variation in the polarization state of the incident image light IL. The variation in the polarization state of the image light IL output from the retardation film 110 toward the +Z side is therefore greater than the variation in the polarization state of the image light IL incident on the retardation film 110 from the −Z side. The configuration of the retardation film 110 and the effect of the retardation film 110 on the image light IL will be described later.

The rotator 150 is disposed at any location outside the optical path of the white light WL and outside the optical path of the image light IL in the projector 501, for example, in a region outside the optical path of each of the multiple types of color light described above in the internal space of the exterior body 5 of the projector 501.

The rotator 150 is electrically coupled to the retardation film 110 via wires or wirelessly. The rotator 150 rotates the retardation film 110 around a center axis parallel to the optical axis AX and the Z-axis. Note that the rotator 150 may be a controller that drives the light emitters 12 of the light source apparatus 10 and the liquid crystal element 60 of the light modulator 50 by supplying appropriate electric signals, voltages, or the like to electrodes of the light emitters 12 and the liquid crystal element 60.

The projection system 100 is disposed on the +Z side of the light collection lens 90 and the retardation film 110, and is disposed in the optical path of the image light IL output from the retardation film 110. The projection system 100 projects the image light IL collected by the light collection lens 90 and passing through the retardation film 110 toward the +Z side along the Z-axis, and enlarges and displays the image light IL on a projection surface such as a screen that is not shown. In the exterior body 5, an opening that is not shown is formed in a region corresponding to the optical path of the image light IL output from the projection system 100, and the image light IL is projected onto the projection surface such as a screen provided outside the projector 501 without being blocked by the exterior body 5.

The projection system 100 is configured, for example, with one or more optical lenses 102. The center of each of the optical lenses 102 in a plane containing the X-axis and the Y-axis is located on the optical axis AX and the Z-axis. The dimension, shape, and curvature of each of the light incident surface and the light exiting surface of each of the optical lenses 102 in the plane containing the X-axis and the Y-axis are designed as appropriate in accordance with the radiation characteristics of the image light IL that enters the projection system 100, the angular distribution and the illuminance distribution of the image light IL around the optical axis AX, and other factors. The optical lenses 102 are each, for example, any refractive lens such as a biconvex lens, a plano-convex lens, a biconcave lens, a plano-concave lens, a meniscus lens, a free-form surface lens, and an aspherical lens, or a cemented lens that is a combination of the refractive lenses described above.

The image generator 210 and the retarder 105 described above constitute an image generation apparatus 200 in the projector 501. The image generator 210, the retarder 105, and the projection system 100 constitute an optical module 220 in the projector 501. In the image generator 210, which includes the liquid crystal element 60, the liquid crystal element 60 is used to impart any amount of phase modulation according to the image information on the projection target to color light incident on the liquid crystal element 60, the color light represented by the image light IL, so that the amount of phase modulation is readily adjusted.

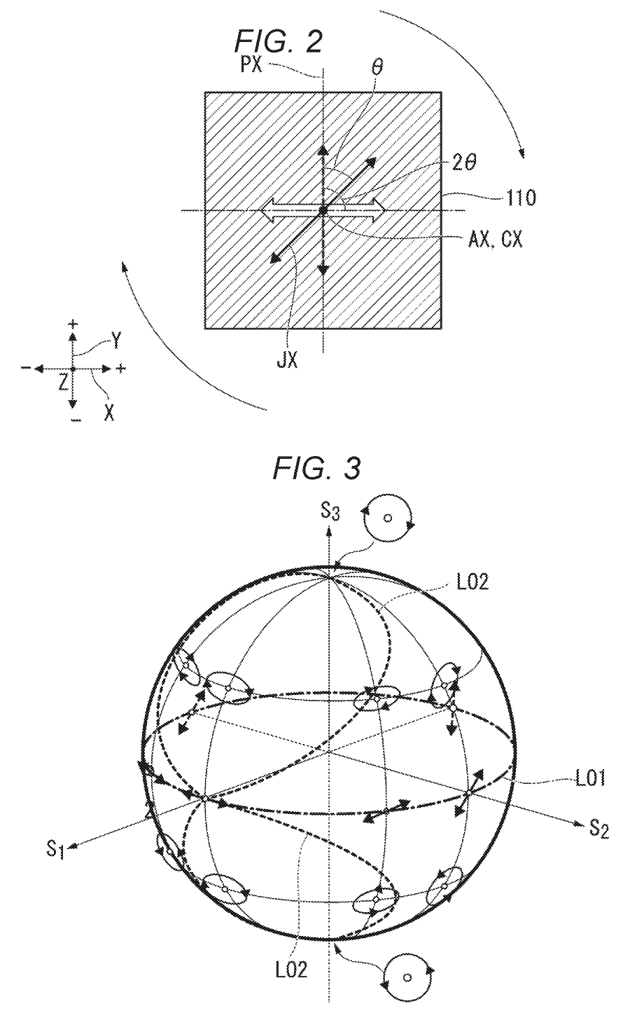

The configuration of the retardation film 110 and the effect of the retardation film 110 on the image light IL will next be described. FIG. 2 is a schematic view of the retardation film 110, and is a front view of the retardation film 110 viewed along the optical axis AX and the Z-axis. The retardation film 110 has a slow axis JX parallel to a plane perpendicular to the optical axis AX, that is, a plane containing the X-axis and the Y-axis, as shown in FIG. 2.

The retardation film 110 can be rotated clockwise or counterclockwise around the center axis CX by the rotator 150, which is not shown in FIG. 2, for example, rotates clockwise. The center axis CX is an axis parallel to the optical axis AX of the image light IL and the Z-axis, for example, coincides with the optical axis AX. The center axis CX may, however, be shifted from the optical axis AX in the plane containing the X-axis and the Y-axis in accordance with the arrangement of a support member that is not shown but supports the retardation film 110 in a rotatable manner as described above and described later.

The retardation film 110 is, for example, a half-wave plate or a quarter-wave plate. When the retardation film 110 is a half-wave plate, a phase difference of λ/2 is imparted to the image light IL incident on the retardation film 110. λ represents a reference wavelength of the image light IL incident on the retardation film 110.

When the retardation film 110 is a half-wave plate, and the predetermined polarized light out of the image light IL, which is polarized in a direction inclining by an angle of 45° with respect to the slow axis JX of the retardation film 110 as indicated by the broken arrow when viewed along the optical axis AX and the Z-axis in the plane containing the X-axis and the Y-axis, is incident, the polarization direction of the predetermined polarized light out of the image light IL relatively rotates by 90° as indicated by the white-solid arrow with respect to the polarization direction at the time of incidence on the retardation film 110, as shown in FIG. 2 by way of example. That is, when the predetermined polarized light out of the image light IL, which is polarized in a direction inclining by an angle θ with respect to the slow axis JX of the retardation film 110, is incident, the polarization direction of the predetermined polarized light out of the image light IL relatively rotates by an angle (2×θ). A phase difference according to the angle between an axis PX along the polarization direction of the image light IL and the slow axis JX in the plane containing the X-axis and the Y-axis is imparted to the image light IL.

When the retardation film 110 is a quarter-wave plate, a phase difference of λ/4 is imparted to the image light IL incident on the retardation film 110. When the retardation film 110 is a quarter-wave plate, and the predetermined polarized light out of the image light IL, which is polarized in the direction inclining by the angle of 45° with respect to the slow axis JX of the retardation film 110 when viewed from the −Z side along the optical axis AX and the Z-axis in the plane containing the X-axis and the Y-axis, is incident, the polarization state of the predetermined polarized light is separated primarily into a polarization state in which the predetermined polarized light is polarized in a direction inclining by an angle of −45° with respect to the polarization direction at the time of incidence on the retardation film 110 and a polarization state in which the predetermined polarized light is polarized in a direction inclining by an angle of +45° with respect to the polarization direction at the time of incidence on the retardation film 110. As a result, circularly polarized light polarized in the clockwise direction is generated.

FIG. 3 is a diagrammatic view showing that the polarization direction of the image light IL output from the retardation film 110 changes when the retardation film 110 rotates around the center axis CX, and shows a change in the polarization direction of the image light IL output from the retardation film 110 in the form of the Poincare sphere. When the retardation film 110 is a half-wave plate, a trajectory LO1 of the polarization direction of the image light IL output from the retardation film 110 rotating around the center axis CX coincides with the equator of the Poincare sphere, as shown in FIG. 3.

When the retardation film 110 is a quarter-wave plate, the trajectory LO2 of the polarization direction of the image light IL output from the retardation film 110 rotating around the center axis CX is an 8-letter-shaped trajectory that is a combination of two trajectories linked to each other at a certain position on the equator: a trajectory passing through the position on the equator and the position of the north pole and circulating in the northern hemisphere; a trajectory passing through the same position on the equator and the position of the south pole and circulating in the southern hemisphere. In practice, an observer who observes the image light IL enlarged and displayed by the projector 501 visually recognizes the image light IL in which the predetermined polarized light according to the light-exiting-side polarizer 80 is canceled and the polarization states on the trajectory LO1 and the trajectory LO2 are superimposed on each other.

When the retardation film 110 is a half-wave plate, the trajectory LO1 coincides with the equator of the Poincare sphere as described above, and it is readily assumed that the image light IL output from the light-exiting-side polarizer 80 and incident on the retardation film 110 is the predetermined polarized light, that is, linearly polarized light having a superimposed polarization state in the image light IL output from the retardation film 110 rotating around the center axis CX.

When the trajectory LO1 of the polarization state of the image light IL output from the retardation film 110 rotating around the center axis CX extends along at least half the circumference of the equator of the Poincare sphere in a unit period of time corresponding to the temporal resolution of the observer, at least two polarization directions perpendicular to each other in the plane containing the X-axis and the Y-axis in the full-color image light IL are reliably superimposed on each other. In this case, speckle contrast that can be achieved by the retardation film 110 rotating around the center axis CX is comparable to speckle contrast achieved by two optical elements having speckle patterns independent of each other, that is, patterns of polarization directions perpendicular to each other, and is 1/sqrt (2). The term sqrt (2) described above means the square root of 2. That is, when the trajectory LO1 extends along at least half the circumference of the equator of the Poincare sphere in the unit period of time for the observer, a maximum speckle contrast that can be achieved by the retardation film 110 rotating around the center axis CX is about a factor of 0.7.

When the trajectory LO1 extends along at least one circumference of the equator of the Poincare sphere in the unit period of time for the observer, the retardation film 110 rotating around the center axis CX changes the polarization state of the image light IL incident on the retardation film 110 back and forth between the polarization state of the initial linearly polarized light and the polarization state of linearly polarized light having a polarization direction perpendicular to that of the initial linearly polarized light. The maximum speckle contrast of 1/sqrt (2) achieved by the polarization superposition in the image light IL is thus reliably provided.

The speed at which the rotator 150 rotates the retardation film 110 around the center axis CX is, for example, greater than or equal to 30 revolutions/sec based on the aforementioned condition that the trajectory LO1 extends along at least half the circumference of the equator of the Poincare sphere in the unit period of time for the observer, and is preferably greater than or equal to 60 revolutions/sec based on the condition that the trajectory LO1 extends along at least one circumference of the equator of the Poincare sphere in the unit period of time for the observer.

The retardation film 110 may, for example, be a retardation film configured with two quartz crystal plates, that is, a generally known quartz crystal waveplate, a retardation film configured with a polymer film, or a retardation member configured with a birefringent material and a polymer film.

In the retardation film configured with two quartz crystal plates, the quartz crystal plates are each thinly cut out along a plane containing a Z-axis in the quartz crystal, that is, a plane containing an axis along the crystal growth direction, and has plate surfaces parallel to the plane containing the X-axis and the Y-axis. The Z-axis in the quartz crystal corresponds to the Z-axis of the quartz crystal described in the claims. The two quartz crystal plates are layered on each other along the Z-axis parallel to the optical axis AX and the center axis CX. Note that the retardation film 110 may be a quartz crystal waveplate configured with three or more quartz plates layered on each other along the Z-axis parallel to the optical axis AX and the center axis CX. In this case, in a predetermined wavelength band that contains the reference wavelength λ of the image light IL and is wider than a wavelength band containing only the reference wavelength λ, for example, in a visible wavelength band from blue to red, the retardation film provides the polarization superposition effect in the image light IL.

The retardation film configured with a polymer film is formed by stretching a polymer film made of resin. In the retardation member configured with a birefringent material and a polymer film, the birefringent material is transparent to the image light IL, and a surface of the polymer film is coated with the birefringent material, so that a phase difference is imparted to the incident image light IL.

The retardation film 110 of the retarder 105 may be a passive retardation film such as the quartz crystal waveplate described above, the waveplate configured with a polymer film described above, or a wire grid polarizer, or may be an active retardation film such as a waveplate configured with a liquid crystal element or the like. In the passive retardation film, a phase difference that is a fixed value is imparted to the image light IL incident on the retardation film 110. When the retardation film 110 is configured with an active retardation film such as a liquid crystal element that is not shown, the angle of inclination of multiple liquid crystal molecules contained in the ON-state liquid crystal layer with respect to the optical axis AX changes due to an increase or a decrease in the voltage applied to the liquid crystal element, so that a phase difference that varies within any width may be imparted to the image light IL. Fine adjustment of the phase difference to be imparted to the image light IL can thus be made.

Note that in a case where the phase difference to be imparted to the image light IL can be adjusted only by increasing or decreasing the voltage applied to the liquid crystal element not rotating around the optical axis AX, the rotator 150 of the retarder 105 may be omitted, and the retarder 105 may be configured only with a liquid crystal element or an active retardation film that is not shown.

The visibility of the speckles produced by the green light and the red light out of the image light IL and viewed by the observer is higher than the visibility of the speckles produced by the blue light of the image light IL and viewed by the observer. The blue wavelength band of the blue light out of the image light IL ranges, for example, from 400 nm to 480 nm. The green wavelength band of the green light out of the image light IL ranges, for example, from 480 nm to 580 nm. The red wavelength band of the red light out of the image light IL ranges, for example, from 580 nm to 680 nm. The retardation film 110 is designed to be optimal in the green wavelength band and the red wavelength band, and is further so designed that the slow axis JX inclining by the exact angle θ acts on the initial predetermined polarized light out of the image light IL in the green wavelength band and the red wavelength band.

The reference wavelength λ of the image light IL is appropriately selected and set in the visible wavelength band of the white light WL, and is preferably a wavelength contained in the green wavelength band and the red wavelength band, for example, a wavelength that falls within a range from 580 nm to 620 nm, considering that the retardation film 110 is designed to be optimal in the green wavelength band and the red wavelength band as described above.

The optical module 220 according to the first embodiment described above includes the light source apparatus 10, the image generation apparatus 200, and the projection system 100. The light source apparatus 10 outputs the white light (light) WL. The image generation apparatus 200 generates the image light IL from the white light WL output from the light source apparatus 10 based on image information. The projection system 100 projects the image light IL output from the image generation apparatus 200 onto the projection surface, which is not shown. The image generation apparatus 200 includes the image generator 210 and the retarder 105. The image generator 210 generates the image light IL from the white light WL output from the light source apparatus 10. The retarder 105 temporally changes the phase difference to be imparted to the image light IL to temporally change the phase difference of the image light IL output from the liquid crystal element 60.

In the optical module 220 according to the first embodiment, the image light IL generated by the liquid crystal element 60 of the image generator 210 passes through the light-exiting-side polarizer 80 and is output from the light-exiting-side polarizer 80 as the predetermined polarized light. The retarder 105 appropriately imparts a plurality of phase differences to the image light IL output from the light-exiting-side polarizer 80 of the image generator 210 in a time-course manner. In this process, the phase difference is imparted to the image light IL output from each of the pixels of the liquid crystal element 60 of the image generator 210, so that the phase difference is also imparted to the entire image light IL output from the modulation region of the liquid crystal element 60. In the optical module 220 according to the first embodiment, the image light IL output from the retarder 105 temporally contains polarized light having multiple polarization states, and when the observer observes the image light IL enlarged and displayed by the projection system 100, the visibility of the speckle noise in the image light IL undergoing the polarization superposition performed by the retarder 105 decreases. The optical module 220 according to the first embodiment, in which no diffuser plate is disposed in the optical path of the white light WL between the light source apparatus 10 and the image generation apparatus 200, can reduce the speckles produced by the image light IL projected from the projection system 100 and suppress the speckle noise in the image light IL even when the image light IL is generated by the image generation apparatus 200 from the white light WL output from the light source apparatus 10, and the polarization state of the image light IL output from the image generation apparatus 200 is maintained at the polarization state of the predetermined polarized light.

In the optical module 220 according to the first embodiment, the retarder 105 includes the retardation film 110 and the rotator 150. The retardation film 110 has the slow axis JX in a plane perpendicular to the optical axis AX of the image light IL output from the liquid crystal element 60 of the image generator 210, that is, in a plane containing the X-axis and the Y-axis. The rotator 150 rotates the retardation film 110 around the center axis CX parallel to the optical axis AX.

In the optical module 220 according to the first embodiment, the phase difference imparted to the image light IL and the degree of the polarization superposition in the image light IL output from the retardation film 110 in accordance with the angle and speed of the rotation of the retardation film 110 can be assumed with high accuracy in accordance with the relative relationship between the polarization direction of the predetermined polarized light out of the image light IL output from the liquid crystal element 60 of the image generator 210 and incident on the retardation film 110 and the slow axis JX of the retardation film 110, that is, the angle θ and the like. In the optical module 220 according to the first embodiment, the retardation film 110 can be rotated at an appropriate speed by the rotator 150 in consideration of the degree of the polarization superposition in the image light IL output from the retardation film 110 in accordance with the angle and speed of the rotation of the retardation film 110, which is assumed as described above, and the degree of the speckles in the image light IL projected from the projection system 100.

In the optical module 220 according to the first embodiment, when the reference wavelength of the image light IL incident on the retarder 105 is λ, the phase difference imparted to the image light IL incident on the retarder 105 is π. Specifically, the retardation film 110 of the retarder 105 is a half-wave plate.

In the optical module 220 according to the first embodiment, for example, the retardation film 110 rotates around the center axis CX at an appropriate speed, so that the phase difference of π is imparted to the image light IL incident on the retardation film 110 of the retarder 105, and the trajectory LO1 of the change in the polarization state of the image light IL extends along at least half the circumference of the equator of the Poincare sphere. The optical module 220 according to the first embodiment can enhance the effect of reducing the speckles in the image light IL output from the projection system 100.

In the optical module 220 according to the first embodiment, the reference wavelength λ of the image light IL incident on the retardation film 110 of the retarder 105 preferably falls within the green wavelength band and the red wavelength band in the visible wavelength band. In this case, when viewed along the center axis CX in a plane perpendicular to the center axis CX of the retardation film 110, that is, in a plane containing the X-axis and the Y-axis, the angle θ between the axis PX along the polarization direction of the image light IL incident on the retardation film 110 of the retarder 105 and the slow axis JX of the retardation film 110 corresponds to a predetermined phase difference imparted to the image light IL having the reference wavelength λ and incident on the retardation film 110. The predetermined phase difference corresponds to λ/2, that is, π when the retardation film 110 is a half-wave plate, and corresponds to λ/4, that is, π/2 when the retardation film 110 is a quarter-wave plate.

In the optical module 220 according to the first embodiment, at the reference wavelength λ that falls within the green wavelength band and the red wavelength band, the angle of the slow axis JX with respect to the axis PX along the polarization direction of the image light IL incident on the retardation film 110 is precisely the angle θ. The optical module 220 according to the first embodiment can reduce the speckles produced by the highly visible green light and red light than the speckles produced by the blue light in the image light IL at the projection surface, and therefore suppress the speckle noise in the entire image light IL.

In the optical module 220 according to the first embodiment, the retardation film 110 is a waveplate configured with two quartz crystal plates that are not shown but are bonded to each other. The plate surfaces of each of the quartz crystal plates are each a surface containing the Z-axis of the quartz crystal.

In the optical module 220 according to the first embodiment, the slow axis JX of the retardation film 110 can be accurately and readily set by using the waveplate configured with two quartz crystal plates bonded to each other as the retardation film 110.

In the optical module 220 according to the first embodiment, the retardation film 110 is a polymer film stretched along a predetermined axis.

In the optical module 220 according to the first embodiment, the retardation film 110 can be readily manufactured, and the cost of the retardation film 110 can be reduced. The retardation film 110 configured with a polymer film may be in contact with a plate surface of another plate-shaped member or the like, so that the degree of freedom in arrangement of the retardation film 110 is increased.

In the optical module 220 according to the first embodiment, the retardation film 110 is a member in which one surface of the polymer film that is not shown is coated with a birefringent material that is not shown but is transparent to the image light IL incident on the retarder 105. The one surface of the polymer film is, for example, a surface of the polymer film that is the surface on which the image light IL is incident.

In the optical module 220 according to the first embodiment, the retardation film 110 can be readily manufactured, and the cost of the retardation film 110 can be reduced.

In the optical module 220 according to the first embodiment, the retarder 105 may include a liquid crystal element.

In the optical module 220 according to the first embodiment, the phase difference imparted to the image light IL incident on the retarder 105 can be readily adjusted by adjusting the voltage applied to the liquid crystal element.

The projector 501 according to the first embodiment includes the optical module 220 according to the first embodiment and the exterior body 5, which houses the optical module 220.

In the projector 501 according to the first embodiment, which includes the optical module 220 described above, the image light IL output from the retarder 105 temporally contains polarized light having multiple polarization states, and when the observer observes the image light IL enlarged and displayed by the projection system 100 on the projection surface such as a screen, the visibility of speckle noise in the image light IL having undergone the polarization superposition decreases. The projector 501 according to the first embodiment, in which no diffuser plate is disposed in the optical path of the white light WL between the light source apparatus 10 and the image generation apparatus 200, can reduce the speckles produced by the image light IL projected from the projection system 100 onto the projection surface and suppress the speckle noise in the image light IL even when the polarization state of the image light IL output from the image generation apparatus 200 is maintained at the polarization state of the predetermined polarized light.

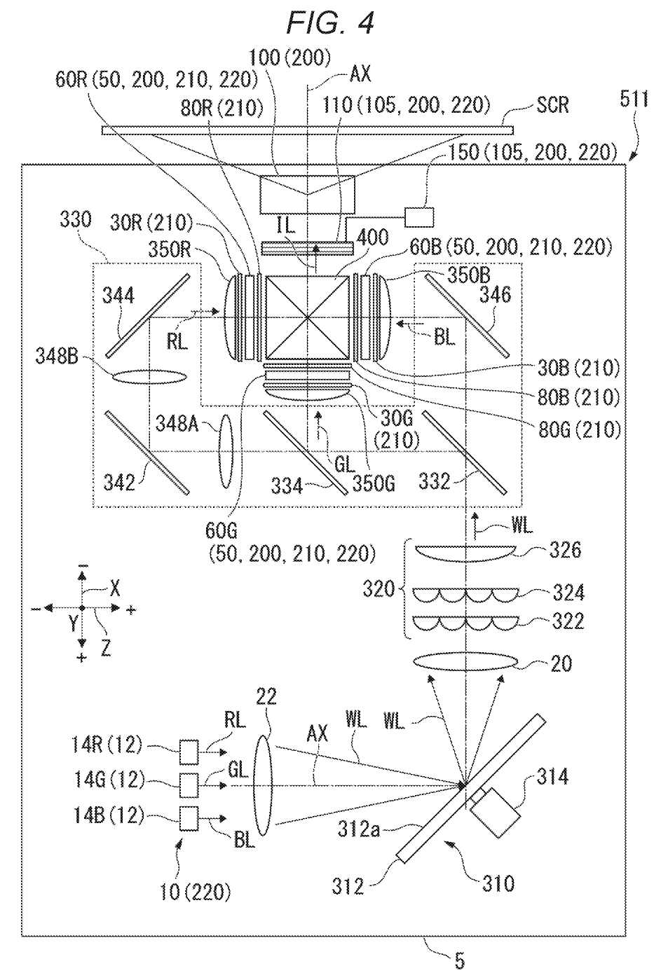

A variation of the first embodiment of the present disclosure will next be described with reference to FIG. 4. FIG. 4 is a schematic view showing the configuration of a projector 511 according to the variation of the first embodiment. The projector 511 is a projection-type image display apparatus including three liquid crystal panels as the light modulator, and is what is called a three-plate projector. The elements of the projector 511 that are common to those of the projector 501 have reference characters that are the same as those of the corresponding elements of the projector 501, and will not be described in detail.

The projector 511 includes the light source apparatus 10, an optical lens 22 as a light collection system, a diffuser 310, the pickup optical system 20, an optical integration system 320, a color separation system 330, relay lenses 348A and 348B, field lenses 350R, 350G, and 350B, light-incident-side polarizers 30R, 30G, and 30B, a liquid crystal element 60R for red light, a liquid crystal element 60G for green light, a liquid crystal element 60B for blue light, light-exiting-side polarizers 80R, 80G, and 80B, a light combining system 400, the retarder 105 in the first embodiment, and the projection system 100, as shown in FIG. 4. FIG. 4 corresponds to a plan view of the projector 511 viewed from the +Y side along the Y-axis.

The multiple light emitters 12 of the light source apparatus 10 are configured with a red LD 14R, a green LD 14G, and a blue LD 14B. The red LD 14R outputs the red light toward the +Z side along the Z-axis. The green LD 14G outputs the green light toward the +Z side along the Z-axis. The blue LD 14B outputs the blue light toward the +Z side along the Z-axis. The red LD 14R, the green LD 14G, and the blue LD 14B are each configured, for example, with a CAN-package-shaped semiconductor laser.

The numbers of the red LDs 14R, the green LDs 14G, and the blue LDs 14B in the light source apparatus 10 and the relative arrangement of the color LDs in a plane containing the X-axis and the Y-axis are appropriately set in accordance with the intensity and the luminance of the color light emitted from each of the red LDs 14R, the green LDs 14G, and the blue LDs 14B and the color balance in the white light WL. The multiple light emitters 12 as a whole emit the white light WL containing red light RL, green light GL, and blue light BL toward the +Z side.

The optical lens 22 as the light collection system is disposed on the +Z side of the light source apparatus 10, and is disposed so as to cover all the optical path of the red light RL, the optical path of the green light GL, and the optical path of the blue light BL emitted from the multiple light emitters 12 of the light source apparatus 10. The optical lens 22 collects the white light WL output from the light source apparatus 10 and directs the collected white light WL toward a predetermined position, specifically, one plate surface 312a of a diffuser plate 312 of the diffuser 310. The optical lens 22 is configured, for example, with one refractive lens, for example, a biconvex lens.

The diffuser 310 includes the diffuser plate 312 and a rotator 314, which rotates the diffuser plate 312. The diffuser plate 312 has the plate surface 312a, on which the white light WL from the optical lens 22 is incident. The plate surface 312a of the diffuser plate 312 inclines by the angle of 45° with respect to the optical axis AX of the white light WL output from the light source apparatus 10 and the Z-axis, and also inclines by the angle of 45° with respect to the X-axis in a plan view viewed along the Y-axis. The plate surface 312a of the diffuser plate 312 specularly reflects the white light WL incident from the −Z side along the Z-axis toward the −X side.

The rotator 314 is, for example, a motor, and rotates the diffuser plate 312 around a center axis that is not shown but is perpendicular to the plate surface 312a. The white light WL that is incident on the diffuser 310 from the −Z side along the Z-axis while being collected is diffusively reflected from the intersection of the optical axis AX of the white light WL and the plate surface 312a of the diffuser plate 312 toward the −X side around the X-axis. The intersection of the optical axis AX of the white light WL and the plate surface 312a of the diffuser plate 312 is shifted from the intersection of the plate surface 312a and the center axis of the diffuser plate 312. When the diffuser plate 312 rotates around the center axis, the illuminance of the white light WL at a plane perpendicular to the optical axis AX and the X-axis, that is, a plane containing the Y-axis and the Z-axis is homogenized.

The pickup optical system 20 is disposed on the −X side of the rotator 314 and is disposed in the optical path of the white light WL output from the rotator 314. The pickup optical system 20 parallelizes the white light WL output from the diffuser plate 312 of the diffuser 310 along the X-axis, and outputs the parallelized white light WL toward the optical integration system 320. The pickup optical system 20 is configured, for example, with a biconvex lens or a plano-convex lens as a collimation lens. The biconvex lens or the plano-convex lens falls within a range where the lens overlaps with the diffuser plate 312 of the diffuser 310 in a plane containing the Y-axis and the Z-axis.

The optical integration system 320 is disposed on the −X side of the pickup optical system 20 and is disposed in the optical path of the white light WL output from the pickup optical system 20. The optical integration system 320 includes a first lens array 322, a second lens array 324, and a superimposing lens 326. The optical integration system 320 divides the white light WL output from the pickup optical system 20 into multiple sub-luminous fluxes in a plane perpendicular to the optical axis AX, and homogenizes the illuminance of the color light in the modulation region of each of liquid crystal elements 60R, 60G, and 60B, which will be described later.

The first lens array 322 includes multiple microlenses. The white light WL output from the pickup optical system 20 is divided by the multiple microlenses of the first lens array 322 into the multiple sub-luminous fluxes, the number of which is equal to the total number of the microlenses, in the plane perpendicular to the optical axis AX, that is, a plane containing the Y-axis and the Z-axis. The multiple microlenses of the first lens array 322 are arranged in a matrix along the Y-axis and the Z-axis in the plane containing the Y-axis and the Z-axis.

The second lens array 324 is disposed on the −X side of the first lens array 322, is disposed within a range where the second lens array 324 coincides with the first lens array 322 in the plane containing the Y-axis and the Z-axis, and is disposed in the optical path of the multiple sub-luminous fluxes of the white light output from the first lens array 322. The second lens array 324 includes multiple microlenses corresponding to the multiple microlenses of the first lens array 322. The multiple microlenses of the second lens array 324 along with the downstream superimposing lens 326 form images of the multiple microlenses of the first lens array 322 in the vicinity of the modulation region of each of the liquid crystal elements 60R, 60G, and 60B of the light modulator 50. The multiple microlenses of the second lens array 324 are arranged in a matrix along the Y-axis and the Z-axis in a plane containing the Y-axis and the Z-axis.

The superimposing lens 326 is disposed on the −X side of the second lens array 324, is disposed within a range where the superimposing lens 326 overlaps with the first lens array 322 and the second lens array 324 in a plane containing the Y-axis and the Z-axis, and is disposed in the optical path of the white light WL output from the second lens array 324. The superimposing lens 326 collects the multiple sub-luminous fluxes of the white light WL output from the first lens array 322 and superimposes the collected multiple sub-luminous fluxes on one another in the vicinity of the modulation region of each of the liquid crystal elements 60R, 60G, and 60B. The superimposing lens 326 is configured, for example, with one refractive lens, for example, a plano-convex lens or a biconvex lens.

The color separation system 330 is disposed in the optical paths of the white light WL and the multiple types of color light output from the superimposing lens 326 of the optical integration system 320. Specifically, the color separation system 330 includes dichroic mirrors 332 and 334 and total reflection mirrors 342, 344, and 346.

The dichroic mirror 332 is disposed on the −X side of the superimposing lens 326 of the optical integration system 320, is disposed within a range where the dichroic mirror 332 overlaps with the superimposing lens 326 in a plane containing the Y-axis and the Z-axis, and is disposed in the optical path of the white light WL output from the superimposing lens 326. The dichroic mirror 332 transmits the blue light BL toward the −X side out of the white light WL incident from the +X side, and reflects the green light GL and the red light RL toward the −Z side out of the white light WL incident from the +X side.

The dichroic mirror 334 is disposed on the −Z side of the dichroic mirror 332, is disposed within a range where the dichroic mirror 334 coincides with the dichroic mirror 332 in a plane containing the X-axis and the Y-axis, and is disposed in the optical paths of the green light GL and the red light RL output from the dichroic mirror 332. The dichroic mirror 334 transmits toward the −Z side the red light RL incident from the +Z side, and reflects toward the −X side the green light GL incident from the +Z side.

The total reflection mirror 342 is disposed on the −Z side of the dichroic mirror 334, is disposed in a range where the total reflection mirror 342 overlaps with the dichroic mirrors 332 and 334 in a plane containing the X-axis and the Y-axis, and is disposed in the optical path of the red light RL output from the dichroic mirror 334. The total reflection mirror 342 reflects the red light RL incident from the +Z side toward the −X side. The total reflection mirror 344 is disposed on the −X side of the total reflection mirror 342, is disposed in a range where the total reflection mirror 344 overlaps with the total reflection mirror 342 in a plane containing the Y-axis and the Z-axis, and is disposed in the optical path of the red light RL output from the total reflection mirror 342. The total reflection mirror 344 reflects the red light RL incident from the +X side toward the +Z side.

The total reflection mirror 346 is disposed on the −X side of the dichroic mirror 332, is disposed in a range where the total reflection mirror 346 overlaps with the dichroic mirror 332 in a plane containing the Y-axis and the Z-axis, and is disposed in the optical path of the blue light BL output from the dichroic mirror 332. The total reflection mirror 346 reflects the blue light BL incident from the +X side toward the −Z side.

The relay lens 348A is disposed in the optical path of the red light RL between the dichroic mirror 334 and the total reflection mirror 342. The relay lens 348B is disposed in the optical path of the red light RL between the total reflection mirror 342 and the total reflection mirror 344. The relay lenses 348A and 348B are provided to reduce loss of the red light RL resulting from the fact that the optical path length of the red light RL from the dichroic mirror 332 to the light combining system 400 is longer than the optical path length of each of the green light GL and the blue light BL from the dichroic mirror 332 to the light combining system 400.

The light combining system 400 is disposed in a region containing the intersection of the optical axis AX of the red light RL output from the total reflection mirror 344, the optical axis AX of the green light GL output from the dichroic mirror 334, and the optical axis AX of the blue light BL output from the total reflection mirror 346. The light combining system 400 is disposed within a range where the light combining system 400 overlaps with the total reflection mirrors 344 and 346 in the X-axis, is disposed within a range where the light combining system 400 overlaps with the dichroic mirrors 332 and 334 and the total reflection mirrors 342, 344, and 346 along the Y-axis, and is disposed within a range where the light combining system 400 overlaps with the dichroic mirror 334 in the Z-axis.

The field lens 350R is disposed in the optical path of the red light RL between the total reflection mirror 344 and the light combining system 400. The field lens 350G is disposed in the optical path of the green light GL between the dichroic mirror 334 and the light combining system 400. The field lens 350B is disposed in the optical path of the blue light BL between the total reflection mirror 346 and the light combining system 400.

The light-incident-side polarizer 30R, the liquid crystal element 60R, and the light-exiting-side polarizer 80R are disposed in the optical path of the red light RL between the field lens 350R and the light combining system 400, and are sequentially arranged from the −Z side toward the +Z side along the Z-axis.

The light-incident-side polarizer 30R is the light-incident-side polarizer 30 that outputs predetermined polarized red light RL out of the white light WL toward the liquid crystal element 60R, and outputs toward the +Z side the predetermined polarized red light RL output from the field lens 350R and incident from the −Z side. The liquid crystal element 60R is the liquid crystal element 60 that generates red image light from the predetermined polarized red light RL, and constitutes the light modulator 50 that generates the red image light. The liquid crystal element 60R modulates the predetermined polarized red light RL output from the light-incident-side polarizer 30R and incident from the −Z side in accordance with an electric signal according to image information input from the image output apparatus to generate the red image light. The light-exiting-side polarizer 80R is the light-exiting-side polarizer 80 that outputs the predetermined polarized red image light toward the projection system 100 via the light combining system 400, and outputs toward the +Z side the predetermined polarized red image light output from the liquid crystal element 60R and incident from the −Z side.

The light-incident-side polarizer 30G, the liquid crystal element 60G, and the light-exiting-side polarizer 80G are disposed in the optical path of the green light GL between the field lens 350G and the light combining system 400, and are sequentially arranged from the +X side toward the −X side along the X-axis.

The light-incident-side polarizer 30G is the light-incident-side polarizer 30 that outputs predetermined polarized green light GL out of the white light WL toward the liquid crystal element 60G, and outputs toward the −X side the predetermined polarized green light GL output from the field lens 350G and incident from the +X side. The liquid crystal element 60G is the liquid crystal element 60 that generates green image light from the predetermined polarized green light GL, and constitutes the light modulator 50 that generates the green image light. The liquid crystal element 60G modulates the predetermined polarized green light GL output from the light-incident-side polarizer 30G and incident from the +X side in accordance with an electric signal according to image information input from the image output apparatus to generate the green image light. The light-exiting-side polarizer 80G is the light-exiting-side polarizer 80 that outputs the predetermined polarized green image light toward the projection system 100 via the light combining system 400, and outputs toward the −X side the predetermined polarized green image light output from the liquid crystal element 60G and incident from the +X side.

The light-incident-side polarizer 30B, the liquid crystal element 60B, and the light-exiting-side polarizer 80B are disposed in the optical path of the blue light BL between the field lens 350B and the light combining system 400, and are sequentially arranged from the +Z side toward the −Z side along the Z-axis.

The light-incident-side polarizer 30B is the light-incident-side polarizer 30 that outputs predetermined polarized blue light BL out of the white light WL toward the liquid crystal element 60B, and outputs toward the −Z side the predetermined polarized blue light BL output from the field lens 350B and incident from the +Z side. The liquid crystal element 60B is the liquid crystal element 60 that generates blue image light from the predetermined polarized blue light BL, and constitutes the light modulator 50 that generates the blue image light. The liquid crystal element 60B modulates the predetermined polarized blue light BL output from the light-incident-side polarizer 30B and incident from the +Z side in accordance with an electric signal according to image information input from the image output apparatus to generate the blue image light. The light-exiting-side polarizer 80B is the light-exiting-side polarizer 80 that outputs the predetermined polarized blue image light toward the projection system 100 via the light combining system 400, and outputs toward the −Z side the predetermined polarized blue image light output from the liquid crystal element 60B and incident from the +Z side.

The light combining system 400 combines the red image light output from the light-exiting-side polarizer 80R, the green image light output from the light-exiting-side polarizer 80G, and the blue image light output from the light-exiting-side polarizer 80B with one another. The light combining system 400 is configured, for example, with a cross dichroic prism configured with four rectangular prisms bonded to each other and therefore having a square shape in a plan view viewed along the Y-axis. In the cross dichroic prism, wavelength separation films or polarization separation films are disposed at the X-shaped interfaces of the rectangular prisms bonded to each other in the plan view. The wavelength separation films or the polarization separation films are each configured, for example, with a dielectric multilayer film.

A first wavelength separation film or a first polarization separation film disposed at the interface that extends from the +X side toward the −X side as extending from the −Z side toward the +Z side out of the X-shaped interfaces in the cross dichroic prism in the plan view reflects the red image light incident from the −Z side along the Z-axis, and transmits the green image light incident from the +X side along the X-axis and the blue image light incident from the +Z side along the Z-axis. A second wavelength separation film or a second polarization separation film disposed at the interface that extends from the −X side toward the +X side as extending from the −Z side toward the +Z side out of the X-shaped interfaces in the cross dichroic prism in the plan view transmits the red image light incident from the −Z side along the Z-axis and the green image light incident from the +X side along the X-axis and reflects the blue image light incident from the +Z side along the Z-axis.

The red image light reflected off the first wavelength separation film or the first polarization separation film, the green image light passing through the first and second wavelength separation films or the first and second polarization separation films, and the blue image light reflected off the second wavelength separation film or the second polarization separation film are superimposed on one another and output toward the −X side of the cross dichroic prism along the X-axis. The light combining system 400 combines the red image light, the green image light, and the blue image light with one another to generate the full-color image light IL, and outputs the image light IL toward the −X side along the X-axis.

In the projector 511, the retardation film 110 of the retarder 105 in the first embodiment is disposed on the −X side of the light combining system 400, is disposed in a range where the retardation film 110 overlaps with the light combining system 400 in a plane containing the Y-axis and the Z-axis, and is disposed in the optical path of the image light IL between the light combining system 400 and the projection system 100. In the projector 511, the retarder 105 rotates around the center axis CX in the same manner in which the retarder 105 operates in the projector 501 to temporally change the phase difference of the image lights IL generated by the multiple types of image light output from the liquid crystal elements 60R, 60G, and 60B and combined with one another. The center axis CX is parallel to the X-axis.

In the projector 511, the projection system 100 is disposed on the −X side of the retardation film 110 and is disposed in the optical path of the image light IL output from the retardation film 110 of the retarder 105. The projection system 100 further projects the image light IL, which is output from the retardation film 110 toward the −X side, along the X-axis toward the −X side, and enlarges and displays the image light IL on the projection surface of a screen SCR.

The optical module 220 in the projector 511 according to the variation of the first embodiment described above includes the light source apparatus 10, the image generation apparatus 200, and the projection system 100, as the optical module 220 in the projector 501 according to the first embodiment. The optical module 220 in the projector 511 provides effects and advantages that are the same as the aforementioned effects and advantages provided by the optical module 220 according to the first embodiment.

Although not shown, in the projector 511 according to the variation of the first embodiment, for example, when wavelength separation films are disposed at the X-shaped interfaces of the cross dichroic prism of the light combining system 400 in the plan view, and the light combining system 400 combines the red image light, the green image light, and the blue image light with one another by using only the wavelength separation function without using the polarization separation function to generate the full-color image light, the retarder 105 may include three retardation films 110. In this case, the three retardation films 110 are disposed in the optical path of the red image light between the light-exiting-side polarizer 80R and the light combining system 400, in the optical path of the green image light between the light-exiting-side polarizer 80G and the light combining system 400, and in the optical path of the blue image light between the light-exiting-side polarizer 80B and the light combining system 400. The rotator 150 may be an apparatus common to the three retardation films 110, or may include three rotators electrically coupled to the three retardation films 110, respectively.

As described above, when the light combining system 400 combines the red image light, the green image light, and the blue image light with one another by using only the wavelength separation function to generate the full-color image light, the retardation film 110 and the rotator 150 disposed in the optical path of the red image light between the light-exiting-side polarizer 80R and the light combining system 400 temporally change the phase difference of the red image light output from the liquid crystal element 60R toward the light combining system 400. The retardation film 110 and the rotator 150 disposed in the optical path of the green image light between the light-exiting-side polarizer 80G and the light combining system 400 temporally change the phase difference of the green image light output from the liquid crystal element 60G toward the light combining system 400. The retardation film 110 and the rotator 150 disposed in the optical path of the blue image light between the light-exiting-side polarizer 80B and the light combining system 400 temporally change the phase difference of the blue image light output from the liquid crystal element 60B toward the light combining system 400.

As described above, when the light combining system 400 combines the red image light, the green image light, and the blue image light with on another by using only the wavelength separation function to generate the full-color image light, the light combining system 400 combines the red image light, the green image light, and the blue image light each having undergone the polarization superposition with one another. In the projector 511, when the light combining system 400 combines the red image light, the green image light, and the blue image light with one another by using only the wavelength separation function to generate the full-color image light, the optical module including the three retardation films 110, the number of which is equal to the number of the liquid crystal elements 60, provides effects and advantages that are the same as the aforementioned effects and advantages provided by the optical module 220 according to the first embodiment.

In the projector 511 according to the variation of the first embodiment, even when the illuminance of the image light IL output from the image generation apparatus 200 at a plane perpendicular to the optical axis AX is homogenized by the diffuser 310 before the image light IL enters the image generation apparatus 200, the speckles produced by the image light IL projected from the projection system 100 onto the projection surface can be reduced, so that the speckle noise in the image light IL can be suppressed.

### Second embodiment

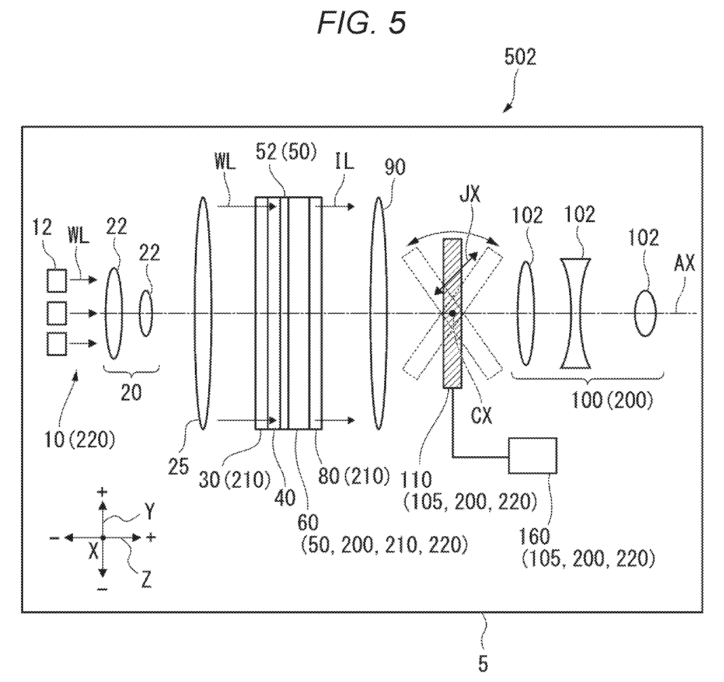

A second embodiment of the present disclosure will next be described with reference to FIGS. 5 to 7. Note in the second embodiment that elements common to those in the first embodiment have reference characters that are the same as those of the corresponding elements in the first embodiment, and no descriptions redundant to those in the first embodiment will be made. In the second embodiment, elements, effects, advantages, and variations different from those in the first embodiment will be primarily described.

FIG. 5 is a schematic view showing the configuration of a projector 502 according to the second embodiment. The projector 502 is a projection-type image display apparatus including one liquid crystal panel as the light modulator, and includes the light source apparatus 10, the pickup optical system 20, the parallelizing lens 25, the light-incident-side polarizer 30, the lens array 40, the light modulator 50, the light-exiting-side polarizer 80, the light collection lens 90, the retarder 105, and the projection system 100.

The retarder 105 in the second embodiment includes the retardation film 110 and a vibrator 160. The vibrator 160 is disposed at any location outside the optical path of the white light WL and outside the optical path of the image light IL in the projector 502, for example, in a region outside the optical path of each of the multiple types of color light described above in the internal space of the exterior body 5 of the projector 502, as the rotator 150. The vibrator 160 corresponds to a rotator that will be described later in the second embodiment, and corresponds to the rotator described in the claims.

The retarder 105, in which the retardation film 110 vibrates around the center axis CX, temporally changes the phase difference imparted to the image light IL to temporally change the phase difference of the image light IL output from the liquid crystal element 60.

The vibrator 160 is electrically coupled to the retardation film 110 via wires or wirelessly. The vibrator 160 rotates the retardation film 110 around a center axis CX to move the retardation film 110 clockwise and counterclockwise with respect to the Y-axis. In the projector 502, the center axis CX passes through the center of the retardation film 110 in a plane containing Y-axis and the Z-axis, is perpendicular to the optical axis AX, and is parallel to the X-axis. The vibrator 160 may be a controller that drives the light emitters 12 of the light source apparatus 10 and the liquid crystal element 60 of the light modulator 50 by supplying appropriate electric signals, voltages, or the like to electrodes of the light emitters 12 and the liquid crystal element 60, as the rotator 150.

The slow axis JX of the retardation film 110 is parallel to the Y-axis when viewed along the Z-axis. The slow axis JX of the retardation film 110 inclines with respect to the Y-axis and the Z-axis when viewed along the X-axis, for example, extends from the −Y side toward the +Y side as extending from the −Z side toward the +Z side, and forms an angle β, that is, an acute angle with respect to the Y-axis extending from the center axis CX toward the +Y side, as shown in FIG. 5. The sign of the angle β is positive when the plate surfaces of the retardation film 110 incline toward the +Z side around the center axis CX with respect to the Y-axis extending from the center axis CX toward the +Y side, and is negative when the plate surfaces of the retardation film 110 incline toward the −Z side around the center axis CX with respect to the Y-axis extending from the center axis CX toward the +Y side.

In the projector 502, the retardation film 110 can be rotated by the vibrator 160 clockwise and counterclockwise around the center axis CX with respect to the Y-axis extending from the center axis CX toward the +Y side. For example, the retardation film 110 alternately rotates counterclockwise and clockwise with respect to the Y-axis extending from the center axis CX toward the +Y side within a range from a negative predetermined angle greater than −90° to a positive predetermined angle smaller than +90°.

The retardation film 110 is, for example, a half-wave plate. When the predetermined polarized light out of the image light IL, which is polarized in the direction parallel to the slow axis JX of the retardation film 110 and the Y-axis when viewed along the optical axis AX and the Z-axis in a plane containing the X-axis and the Y-axis, is incident, the polarization state of the predetermined polarized light out of the image light IL relatively rotates in accordance with the angle β with respect to the polarization direction at the time of incidence on the retardation film 110, and at least a phase difference φ according to the angle β is imparted to the image light IL.

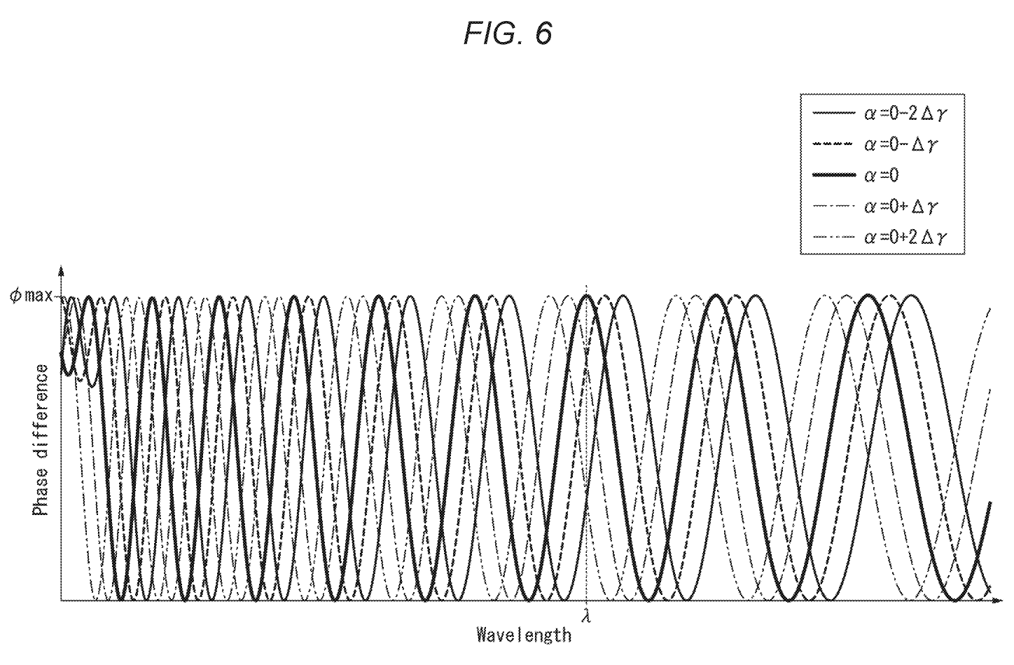

FIG. 6 shows diagrammatic graphs illustrating the wavelength dependence of the phase difference φ imparted to the multiple types of color light when the image light IL is incident on the retardation film 110 of the retarder 105 in the second embodiment. The horizontal axis of FIG. 6 represents the wavelengths of the multiple types of color light incident on the retardation film 110, for example, the wavelengths that falls within the visible wavelength band. The vertical axis of FIG. 6 represents the phase difference φ at the wavelengths of the multiple types of color light incident on the retardation film 110. When viewed along the X-axis, let α be the angle of the plate surfaces of the retardation film 110 rotating around the center axis CX with respect to the Y-axis extending from the center axis CX toward the +Y side.

In the second embodiment, when viewed from the +X side along the X-axis as shown in FIG. 5, the sign of the angle is positive when measured in the clockwise rotation with respect to the Y-axis extending from the center axis CX toward the +Y side, and is negative when measured in the counterclockwise rotation with respect to the Y-axis extending from the center axis CX toward the +Y side. The angle is expressed in degrees unless otherwise specified. FIG. 6 shows the phase difference φ in a case where the angle α is 0°, in a case where the retardation film 110 rotates by predetermined angles −Δγ and +Δγ, and in a case where the retardation film 110 rotates by twice the predetermined angles −2Δγ and +2Δγ.

When the angle α is 0°, the phase difference φ reaches a maximum phase difference φmax at the reference wavelength λ. The maximum phase difference φmax is, for example, π and corresponds to λ/2. That is, in the projector 502, the retardation film 110 imparts the maximum phase difference φmax to the image light having the reference wavelength λ and polarized in the direction parallel to the Y-axis. When the angle α is 0°, and the wavelength of the image light IL incident on the retardation film 110 of the retarder 105 is longer than the reference wavelength λ, the phase difference φ repeatedly increases and decreases between zero and the maximum phase difference φmax. Also when the wavelength of the image light IL incident on the retardation film 110 of the retarder 105 is shorter than the reference wavelength λ, the phase difference φ repeatedly increases and decreases between zero and the maximum phase difference φmax. The cycle of the increase and decrease of the phase difference φ becomes relatively longer as the wavelength of the image light IL incident on the retardation film 110 becomes longer.

When the angle α is greater than 0° and increases to (0+Δγ)° or (0+2Δγ)°, the phase difference φ has wavelength dependence indicated by the same waveform for the angle α being 0°, which increases and decreases in the predetermined wavelength band containing the reference wavelength λ, but reaches the maximum phase difference φmax at a wavelength different from the wavelength at which the phase difference φ reaches the maximum phase difference φmax when the angle α is 0°. The wavelength at which the phase difference φ reaches the maximum phase difference φmax when α > 0 is relatively shorter than the wavelength at which the phase difference φ reaches the maximum phase difference φmax when α = 0. The amount of shift of the profile indicating the wavelength dependence of the phase difference φ toward a shorter wavelength for α > 0 from the profile indicating the wavelength dependence of the phase difference φ for α = 0 is proportional to Δγ. The amount of shift of the wavelength at which the phase difference φ reaches the maximum phase difference φmax for α > 0 toward a shorter wavelength from the wavelength at which the phase difference φ reaches the maximum phase difference φmax for α = 0 is proportional to Δγ.

Also when the angle α is smaller than 0° and decreases to (0−Δγ)° or (0−2Δγ)°, the phase difference φ has wavelength dependence indicated by the same waveform for the angle α being 0°, which increases and decreases in the predetermined wavelength band containing the reference wavelength λ, but reaches the maximum phase difference φmax at a wavelength different from the wavelength at which the phase difference φ reaches the maximum phase difference φmax when the angle α is 0°. The wavelength at which the phase difference φ reaches the maximum phase difference φmax when α < 0 is relatively longer than the wavelength at which the phase difference φ reaches the maximum phase difference φmax when α = 0. The amount of shift of the profile indicating the wavelength dependence of the phase difference φ toward a longer wavelength for α < 0 from the profile indicating the wavelength dependence of the phase difference φ for α = 0 is proportional to Δγ. The amount of shift of the wavelength at which the phase difference φ reaches the maximum phase difference φmax for α < 0 toward a longer wavelength from the wavelength at which the phase difference φ reaches the maximum phase difference φmax for α = 0 is proportional to Δγ.

The amount of shift of the profile indicating the wavelength dependence of the phase difference φ for α = (0−Δγ)° toward a longer wavelength from the profile indicating the wavelength dependence of the phase difference φ for α = 0 is comparable to the amount of shift of the profile indicating the wavelength dependence of the phase difference φ for α = (0+Δγ)° toward a longer wavelength from the profile indicating the wavelength dependence of the phase difference φ for α = 0.

When the retardation film 110 vibrates in a range from an angle −γ to an angle +γ around the center axis CX within the unit period of time corresponding to the temporal resolution of the observer, and the shift of the wavelength at which the phase difference φ imparted to the image light IL by the retardation film 110 reaches the maximum phase difference φmax extends over the entire visible wavelength band, the phase difference of π is imparted to the full-color image light IL, and at least two polarization directions perpendicular to each other in the plane containing the X-axis and the Y-axis are reliably superimposed on each other. In this case, the speckle contrast that can be achieved by the retardation film 110 rotating around the center axis CX to vibrate with respect to the Y-axis is comparable to the speckle contrast achieved by two optical elements having speckle patterns independent of each other, that is, patterns of polarization directions perpendicular to each other, and is 1/sqrt (2). That is, when the shift of the wavelength at which the phase difference φ imparted to the image light IL by the retardation film 110 within the unit period of time for the observer reaches the maximum phase difference φmax extends over the entire visible wavelength band, the maximum speckle contrast that can be achieved by the retardation film 110 rotating around the center axis CX is about a factor of 0.7.

When the shift of the wavelength at which the phase difference φ imparted to the image light IL by the retardation film 110 within the unit period of time for the observer reaches the maximum phase difference φmax extends over the entire visible wavelength band, the retardation film 110 rotating around the center axis CX changes the polarization state of the image light IL incident on the retardation film 110 back and forth between the polarization state of the initial linearly polarized light and the polarization state of linearly polarized light having a polarization direction perpendicular to that of the initial linearly polarized light. The maximum speckle contrast of 1/sqrt (2) achieved by the polarization superposition in the image light IL is thus reliably provided.

The speed at which the vibrator 160 rotates the retardation film 110 around the center axis CX to vibrate the retardation film 110 with respect to the Y-axis is, for example, greater than or equal to 30 vibrations/sec, preferably, greater than or equal to 60 vibrations/sec based on the condition that the shift of the wavelength at which the phase difference φ imparted to the image light IL in the unit period of time for the observer reaches the maximum phase difference φmax extends over the entire visible wavelength band as described above. The controlled speed of the vibrator 160 is preferably higher than or equal to 60 Hz. One vibration means that the plate surfaces of the retardation film 110 move around the center axis CX once from predetermined angles −γ° to +γ ° or from +γ° to −γ° with respect to the Y-axis extending from the center axis CX toward the +Y side in a way that the shift of the wavelength at which the phase difference φ imparted to the image light IL reaches the maximum phase difference φmax extends over the entire visible wavelength band.

As described in the first embodiment, the visibility of the speckles produced by the green light and the red light out of the image light IL and viewed by the observer is higher than the visibility of the speckles produced by the blue light out of the image light IL and viewed by the observer. Therefore, the retardation film 110 is designed to be optimal in the green wavelength band and the red wavelength band, and is further so designed that the slow axis JX inclining by the exact angle β acts on the initial predetermined polarized light out of the image light IL in the green wavelength band and the red wavelength band.

Note in the above description that it is assumed that the slow axis JX of the retardation film 110 of the retarder 105 is parallel to the Y-axis when viewed along the Z-axis, and that θ = 0°, and it may instead be assumed that θ > 0° as shown, for example, in FIG. 2 and, that, for example, 0° < θ < 90°. In this case, the amount of shift of the profile indicating the wavelength dependence of the phase difference φ for α = (0−Δγ)° toward a longer wavelength from the profile indicating the wavelength dependence of the phase difference φ for α = 0 differs from the amount of shift of the profile indicating the wavelength dependence of the phase difference φ for α = (0+Δγ)° toward a longer wavelength from the profile indicating the wavelength dependence of the phase difference φ for α = 0.

In the optical module 220 according to the second embodiment and the projector 502, the wavelength dependence of the phase difference φ in the case where 0° < θ < 180° or 180° < θ < 360° and the plate surfaces of the retardation film 110 vibrate around the center axis CX with respect to the Y-axis extending from the center axis CX toward the +Y side from the predetermined angles −γ° to +γ°, that is, the shift of the profile indicating the wavelength dependence of the phase difference φ along the wavelength axis is greater than the wavelength dependence of the phase difference φ in the case where 0° = θ and the plate surfaces of the retardation film 110 vibrate around the center axis CX with respect to the Y-axis extending from the center axis CX toward the +Y side from the predetermined angles −γ° to +γ°, that is, the shift of the profile representing the wavelength dependence of the phase difference φ along the wavelength axis.

Even in the case where 0° < θ < 180° or 180° < θ < 360° is satisfied, the speed at which the vibrator 160 rotates the retardation film 110 around the center axis CX to vibrate the retardation film 110 with respect to the Y-axis is appropriately set based on the condition that the shift of the wavelength at which the phase difference φ imparted to the image light IL in the unit period of time for the observer reaches the maximum phase difference φmax extends over the entire visible wavelength band. Note that the angle at which the plate surfaces of the retardation film 110 vibrate toward the positive side with respect to the Y-axis extending from the center axis CX toward the +Y side and the angle at which the plate surfaces vibrate toward the negative side with respect to the Y-axis may differ from each other.

The retardation film 110 of the retarder 105 in the second embodiment rotates around the center axis CX parallel to the X-axis perpendicular to the optical axis AX of the incident image light IL, and vibrates clockwise or counterclockwise with respect to the Y-axis around the center axis CX perpendicular to the optical axis AX and the Z-axis. An image output from the pixels of the liquid crystal elements 60R, 60G, and 60B and projected onto the projection surface of the screen that is not shown is repeatedly shifted in the vertical direction of the projection surface, that is, toward the +Y side or the −Y side in accordance with the cycle of the rotation and vibration of the retardation film 110. The resolution of the image displayed on the projection surface is therefore higher than the resolution in the modulation region of each of the liquid crystal elements 60R, 60G, and 60B. That is, the retardation film 110 of the retarder 105 is rotated by the vibrator 160 around the center axis CX and vibrates clockwise or counterclockwise with respect to the Y-axis, so that a pixel enhancement effect along one axis is provided.

Although not shown, the retardation film 110 of the retarder 105 in the second embodiment may rotate around the center axis CX parallel to the X-axis perpendicular to the optical axis AX of the incident image light IL, and vibrate clockwise or counterclockwise with respect to the Y-axis around the center axis CX perpendicular to the optical axis AX and the center axis CX. Also in this case, the resolution of the image displayed on the projection surface of the screen is higher than the resolution in the modulation region of each of the liquid crystal elements 60R, 60G, and 60B, so that the pixel enhancement effect along one axis is provided.

Instead, the retardation film 110 of the retarder 105 in the second embodiment may rotate around either the center axis CX parallel to the X-axis perpendicular to the optical axis AX of the incident image light IL and the center axis CX parallel to the Y-axis alternately in time series, and vibrate clockwise or counterclockwise around the center axis CX with respect to the Y-axis or the X-axis. In this case, the resolution of the image displayed on the projection surface of the screen is further increased as compared with the resolution in the modulation region of each of the liquid crystal elements 60R, 60G, and 60B, so that a pixel enhancement effect along two axes is provided.

To provide the pixel enhancement effect along one axis or two axes, the distance by which the image from the pixels of each of the liquid crystal elements 60R, 60G, and 60B is shifted at the projection surface such as a screen is, for example, comparable to the dimension of each of the pixels of each of the liquid crystal elements 60R, 60G, and 60B along the Y-axis, and is assumed based on the dimension of each of the pixels in the direction in which the image is shifted. However, when priority is given to the configuration in which the rotation speed and the vibration speed of the retardation film 110 are appropriately set based on the condition that the shift of the wavelength at which the phase difference φ imparted to the image light IL in the unit period of time for the observer reaches the maximum phase difference φmax extends over the entire visible wavelength band, and the angle γ° at which the retardation film 110 rotates and vibrates and the distance between the plate surfaces of the retardation film 110, that is, the thickness thereof is set as described above, it is conceivable that the amount of shift of the pixels at the surface where the image light IL is projected is excessively large.

Although not shown, the optical module 220 according to the second embodiment may further include a moving mechanism that is not shown. When the retardation film 110 is rotated and vibrated by the vibrator 160 based on the aforementioned optimum condition regarding the phase difference φ, and the amount of shift of the pixels at the surface where the image light IL is projected is excessively large, the moving mechanism moves the retardation film 110 in the direction opposite the direction in which the pixels are shifted by the excessive amount of shift in a plane perpendicular to the optical axis AX, that is, a plane containing the X-axis and the Y-axis. The moving mechanism allows both an optimum phase difference φ imparted to the image light IL incident on the retardation film 110 and an optimum amount of shift of the pixels at the surface where the image light IL is projected.

When the retardation film 110 is rotated and vibrated by the vibrator 160 based on the aforementioned optimum condition regarding the phase difference φ, and the amount of shift of the pixels at the surface where the image light IL is projected is excessively small, the moving mechanism moves the retardation film 110 in the same direction in which the pixels are shifted by an insufficient amount of shift in the plane perpendicular to the optical axis AX, that is, the plane containing the X-axis and the Y-axis.

The moving mechanism that is not shown is electrically coupled to the retardation film 110 via wires or wirelessly, and may be disposed in the internal space of the exterior body 5 independently of the vibrator 160, or the vibrator 160 may also function as the moving mechanism.

The optical module 220 according to the second embodiment described above includes the light source apparatus 10, the image generation apparatus 200, and the projection system 100. In the optical module 220 according to the second embodiment, the image light IL generated by the liquid crystal elements 60R, 60G, and 60B of the image generator 210 passes through the light-exiting-side polarizers 80R, 80G, and 80B and is output from the light-exiting-side polarizers 80R, 80G, and 80B as the predetermined polarized light. The retarder 105 appropriately imparts a plurality of phase differences to the image light IL output from the light-exiting-side polarizers 80R, 80G, and 80B of the image generator 210 in a time-course manner. In this process, a phase difference is imparted to the image light IL output from the pixels of the liquid crystal elements 60R, 60G, and 60B of the image generator 210, and the phase difference is also imparted to the entire image light IL output from the modulation regions of the liquid crystal elements 60R, 60G, and 60B.

In the optical module 220 according to the second embodiment, the image light IL output from the retarder 105 contains polarized light having multiple polarization states in time series, so that when the observer observes the image light IL enlarged and displayed by the projection system 100, the visibility of speckle noise in the image light IL undergoing the polarization superposition performed by the retarder 105 decreases. The optical module 220 according to the second embodiment, in which a diffuser plate is disposed in the optical path of the white light WL between the light source apparatus 10 and the image generation apparatus 200, causes the image light IL to undergo the polarization superposition, can therefore further reduce the speckles produced by the image light IL projected from the projection system 100 and further suppress the speckle noise in the image light IL even when the image light IL is generated by the image generation apparatus 200 from the white light WL output from the light source apparatus 10 and the polarization state of the image light IL output from the image generation apparatus 200 is maintained at the polarization state of the predetermined polarized light.

The optical module 220 according to the second embodiment provides effects and advantages based on the elements common to those of the optical module 220 according to the first embodiment.

In the optical module 220 according to the second embodiment, the retarder 105 includes the retardation film 110 and the vibrator (rotator) 160. The retardation film 110 has the slow axis JX in a plane containing the optical axis AX of the image light IL output from the liquid crystal element 60 of the image generator 210, for example, in a plane containing the Y-axis and the Z-axis, or in a plane containing the Z-axis and an axis inclining by the angle θ with respect to the Y-axis and the X-axis. The vibrator (rotator) 160 rotates the retardation film 110 around the center axis CX perpendicular to the aforementioned plane containing the optical axis AX and parallel to the X-axis to vibrate the retardation film 110 clockwise and counterclockwise with respect to the Y-axis when viewed along the center axis CX.

In the optical module 220 according to the second embodiment, the degree of the polarization superposition in the image light IL output from the retardation film 110 can be assumed with high accuracy in accordance with the relative relationship between the polarization direction of the predetermined polarized light out of the image light IL output from the liquid crystal element 60 of the image generator 210 and incident on the retardation film 110 and the slow axis JX of the retardation film 110, that is, the angle β, the angle θ and the like. In the optical module 220 according to the second embodiment, the vibrator 160 can rotate the retardation film 110 at an appropriate speed and vibrate the retardation film 110 at an appropriate speed in consideration of the degree of the polarization superposition in the image light IL output from the retardation film 110 in accordance with the angle of the rotation and the speed of the vibration of the retardation film 110, which is assumed as described above, and the degree of the speckles in the image light IL projected from the projection system 100.

The optical module 220 according to the second embodiment, in which the retardation film 110 of the retarder 105 rotates around the axis perpendicular to a plane containing the optical axis AX of the incident image light IL, that is, the center axis CX parallel to the X-axis or the center axis CX parallel to the Y-axis, can provide the image enhancement effect to increase the resolution of an image formed by the image light IL at the projection surface. Since the retardation film 110 is disposed as appropriate in the optical paths of the multiple types of color light between the liquid crystal elements 60R, 60G, and 60B of the light modulator 50 and the projection system 100, an increase in size of the optical module 220 is suppressed.

In the optical module 220 according to the second embodiment, when the retardation film 110 rotates by the angle (predetermined maximum angle) γ° with respect to the Y-axis (axis) perpendicular to the center axis CX in a plane containing the optical axis AX, that is, a plane containing the Y-axis and the Z-axis, or a plane containing the Z-axis and an axis inclining by the angle θ with respect to the Y-axis and the X-axis, the phase difference of π is imparted to the image light IL incident on the retardation film 110 of the retarder 105.

In the optical module 220 according to the second embodiment, for example, the retardation film 110 rotates around the center axis CX by the angle γ°, which corresponds to an optimum range, and vibrates around the center axis CX with respect to the Y-axis, so that the phase difference of π is imparted to the image light IL incident on the retardation film 110 of the retarder 105. The optical module 220 according to the second embodiment can enhance the effect of reducing the speckles in the image light IL output from the projection system 100.

The optical module 220 according to the second embodiment may further include a moving mechanism that is not shown. The moving mechanism moves the retardation film 110 along the direction in which the image light IL projected from the projection system 100 is shifted in a plane containing the X-axis and the Y-axis in accordance with the phase difference φ and the dimension of the retardation film in the direction along the optical axis AX, that is, the dimension along the Z-axis or the thickness at α = 0°.

In the optical module 220 according to the second embodiment, when the thickness, the angle of the rotation, and the angle of the vibration of the retardation film 110 are set in accordance with the phase difference φ imparted to the image light IL incident on the retardation film 110, and even when the amount of shift of the image light IL at the projection surface is excessive or insufficient to provide a favorable image enhancement effect, the retardation film 110 can be moved by the moving mechanism along the direction in which the image light IL is shifted at the projection surface to correct the excessive amount of shift or the insufficient amount of shift, so that an appropriate amount of shift of the image light IL can be achieved. The optical module 220 according to the second embodiment can achieve both an appropriate phase difference φ imparted to the image light IL incident on the retardation film 110 and an appropriate amount of shift of the image light IL at the projection surface such as a screen, reduce the speckles produced by the image light IL at the projection surface, and increase the resolution of an image or a video formed by the image light IL at the projection surface.

The projector 502 according to the second embodiment includes the optical module 220 according to the second embodiment and the exterior body 5.

The projector 502 according to the second embodiment, in which no diffuser plate is disposed in the optical path of the white light WL between the light source apparatus 10 and the image generation apparatus 200, can reduce the speckles produced by the image light IL projected from the projection system 100 onto the projection surface and suppress the speckle noise in the image light IL even when the polarization state of the image light IL output from the image generation apparatus 200 is maintained at the polarization state of the predetermined polarized light.

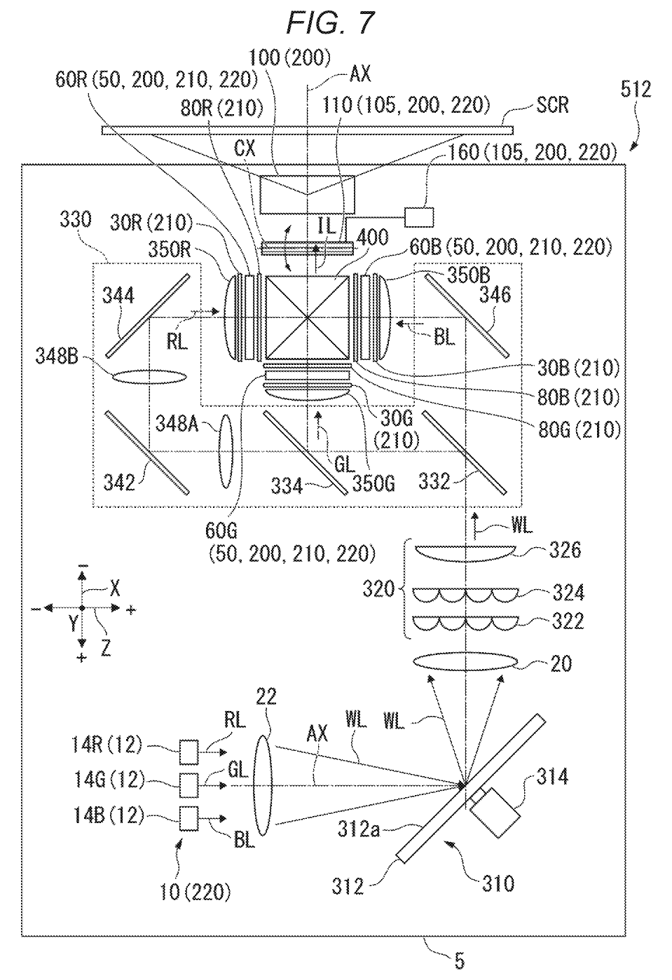

A variation of the second embodiment of the present disclosure will next be described with reference to FIG. 7. FIG. 7 is a schematic view showing the configuration of a projector 512 according to the variation of the second embodiment. The projector 512 is a projection-type image display apparatus including three liquid crystal panels as the light modulator, and is what is called a three-plate projector, as the projector 511 described with reference to FIG. 4. The elements of the projector 512 that are common to those of the projectors 501 and 511 have reference characters that are the same as those of the corresponding elements of the projectors 501 and 511, and will not be described in detail.

The projector 512 includes the light source apparatus 10, the optical lens 22 as the light collection system, the diffuser 310, the pickup optical system 20, the optical integration system 320, the color separation system 330, the relay lenses 348A and 348B, the field lenses 350R, 350G, and 350B, the light-incident-side polarizers 30R, 30G, and 30B, the liquid crystal element 60R for red light, the liquid crystal element 60G for green light, the liquid crystal element 60B for blue light, the light-exiting-side polarizers 80R, 80G, and 80B, the light combining system 400, the retarder 105 in the second embodiment, and the projection system 100, as shown in FIG. 7. FIG. 7 corresponds to a plan view of the projector 512 viewed from the +Y side along the Y-axis.

In the projector 512, the retardation film 110 of the retarder 105 in the second embodiment is disposed on the −X side of the light combining system 400, is disposed in a range where the retardation film 110 overlaps with the light combining system 400 in a plane containing the Y-axis and the Z-axis, and is disposed in the optical path of the image light IL between the light combining system 400 and the projection system 100. The center axis CX is parallel to the Z-axis. In the projector 512, the retarder 105 rotates around the center axis CX in the same manner in which the retarder 105 operates in the projector 502 to temporally change the phase difference of the image lights IL generated by the multiple types of image light output from the liquid crystal elements 60R, 60G, and 60B and combined with one another.

The optical module 220 in the projector 512 according to the variation of the second embodiment includes the light source apparatus 10, the image generation apparatus 200, and the projection system 100, as the optical module 220 in the projector 502 according to the second embodiment. The optical module 220 in the projector 512 provides effects and advantages that are the same as the aforementioned effects and advantages provided by the optical module 220 in the second embodiment.

Also in the projector 512 according to the variation of the second embodiment, for example, when wavelength separation films are disposed at the X-shaped interfaces of the cross dichroic prism of the light combining system 400 in the plan view, and the light combining system 400 combines the red image light, the green image light, and the blue image light with one another by using only the wavelength separation function without using the polarization separation function to generate the full-color image light, the retarder 105 may include three retardation films 110 disposed in correspondence with the liquid crystal elements 60R, 60G, and 60B.

In the projector 512 according to the variation of the second embodiment, even when the illuminance of the image light IL output from the image generation apparatus 200 at a plane perpendicular to the optical axis AX is homogenized by the diffuser 310 before the image light IL enters the image generation apparatus 200, the speckles produced by the image light IL projected from the projection system 100 onto the projection surface can be reduced, so that the speckle noise in the image light IL can be suppressed.

Preferable embodiments of the present disclosure have been described above in detail. The present disclosure is, however, not limited to the specific embodiments described above, and various modifications and changes can be made thereto within the scope of key points of the present disclosure described in the claims. The elements of the multiple embodiments can be combined with each other as appropriate.

For example, in the embodiments and the variations of the embodiments described above, the liquid crystal elements 60, 60R, 60G, and 60B of the light modulator 50 of the image generator 210 may each be replaced with a digital micromirror device (DMD). Disposing the DMDs changes as appropriate the optical elements other than the DMDs in each of the projectors and each of the optical modules. That is, the image generator 210 may include, for example, the DMDs in place of the liquid crystal element 60 or the liquid crystal elements 60R, 60G, and 60B.

Although the single-plate projector is presented by way of example in each of the embodiments described above, and the three-plate projector is presented by way of example in the variation of each of the embodiments, the projector including the optical module 220 according to each of the embodiments is not limited to the single-plate or three-plate projector, and may, for example, be a two-plate projector. For example, in the color separation system 330 of each of the projectors 511 and 512 according to the variations of the embodiments, two out of the red light RL, the green light GL, and the blue light BL may be so superimposed on each other that the optical paths thereof coincide with each other, a liquid crystal element that generates image light from the two types of color light may at least alternately generate image light having one of the two colors and image light having the other color in a time division manner in the unit period of time for the observer, and another liquid crystal element that generates image light from the color light having the remaining one color out of the three colors may operate in conjunction with the liquid crystal element that generate the two types of image light.

### Summary of present disclosure

The present disclosure will be summarized below as additional remarks.

Additional Remark 1: An optical module includes: a light source apparatus configured to output light; an image generation apparatus configured to generate image light from the light output from the light source apparatus based on image information; and a projection system configured to project light output from the image generation apparatus. The image generation apparatus includes an image generator configured to generate the image light from the light output from the light source apparatus, and a retarder configured to temporally change a phase difference of the image light output from the image generator.

The configuration described in Additional Remark 1 can reduce speckles produced by the image light projected from the projection system and suppress speckle noise in the image light even when the image generation apparatus generates the image light from the light output from the light source apparatus and the polarization state of the image light output from the image generation apparatus is maintained at the polarization state of predetermined polarized light.

Additional Remark 2: The optical module according to Additional Remark 1, wherein the retarder includes a retardation film having a slow axis in a plane perpendicular to an optical axis of the image light output from the image generator, and a rotator configured to rotate the retardation film around a center axis parallel to the optical axis.

According to the configuration described in Additional Remark 2, a phase difference imparted to the image light and the degree of the polarization superposition in the image light output from the retardation film in accordance with the angle and the speed of the rotation of the retardation film can be assumed with high accuracy. The configuration described in Additional Remark 2 allows the rotator to rotate the retardation film at an appropriate speed in consideration of the degree of the polarization superposition in the image light output from the retardation film and the degree of the speckles produced by the image light projected from the projection system.

Additional Remark 3: The optical module according to Additional Remark 1 or 2, wherein when a reference wavelength of the image light incident on the retarder is λ, a phase difference imparted to the image light incident on the retarder is π.

According to the configuration described in Additional Remark 3, since the phase difference of π is imparted to the image light incident on the retardation film of the retarder, and the trajectory of the change in the polarization state of the image light may extend along at least half the circumference of the equator of the Poincare sphere, the state of the image light corresponds to a state in which two types of polarized light polarized in directions perpendicular to each other when viewed along the optical axis of the image light are superimposed on each other, so that the effect of reducing the speckles produced by the image light output from the projection system can be enhanced.

Additional Remark 4: The optical module according to Additional Remark 2, wherein a reference wavelength of the image light incident on the retarder falls within a green wavelength band and a red wavelength band in a visible wavelength band, and an angle between an axis along a polarization direction of the image light incident on the retarder and the slow axis in a view viewed along the center axis in a plane perpendicular to the center axis corresponds to the phase difference at the reference wavelength.

According to the configuration described in Additional Remark 4, when the light output from the light source apparatus is visible light containing blue light, green light, and red light, the speckles produced by the green light and the red light out of the image light and having higher visibility than the speckles produced by the blue light out of the image light at a projection surface can be reduced, so that the speckle noise in the entire image light can be suppressed.

Additional Remark 5: The optical module according to Additional Remark 2 or 4, wherein the retardation film is a waveplate configured with two quartz crystal plates bonded to each other, and a plate surface of each of the quartz crystal plates is a surface containing a Z-axis of the quartz crystal.

According to the configuration described in Additional Remark 5, the slow axis of the retardation film can be accurately and readily set by using the waveplate configured with two quartz crystal plates bonded to each other as the retardation film.

Additional Remark 6: The optical module according to Additional Remark 2 or 4, wherein the retardation film is a stretched polymer film.

According to the configuration described in Additional Remark 6, the retardation film can be readily manufactured, and the cost of the retardation film can be reduced.

Additional Remark 7: The optical module according to Additional Remark 2 or 4, wherein the retardation film is a member configured with a polymer film having one surface coated with a birefringent material transparent to the image light incident on the retarder.

According to the configuration described in Additional Remark 7, the retardation film can be readily manufactured, and the cost of the retardation film can be reduced.

Additional Remark 8: The optical module according to Additional Remark 1, wherein the retarder includes a retardation film having a slow axis inclining with respect to an optical axis of the image light output from the image generator in a plane containing the optical axis, and a rotator configured to rotate the retardation film around a center axis perpendicular to the plane containing the optical axis.

According to the configuration described in Additional Remark 8, a phase difference imparted to the image light and the degree of the polarization superposition in the image light output from the retardation film in accordance with the angle and the speed of the rotation of the retardation film can be assumed with high accuracy. The configuration described in Additional Remark 8 allows the rotator to rotate the retardation film at an appropriate speed in consideration of the degree of the polarization superposition in the image light output from the retardation film and the degree of the speckles produced by the image light projected from the projection system. The configuration described in Additional Remark 8, in which the retardation film of the retarder rotates around the axis perpendicular to the plane containing the optical axis of the incident image light, provides an image enhancement effect, so that the resolution of an image formed at the projection surface by the image light can be increased.

Additional Remark 9: The optical module according to Additional Remark 8, wherein when the retardation film rotates by a predetermined maximum angle with respect to an axis perpendicular to the center axis in the plane containing the optical axis, a phase difference of π is imparted to the image light incident on the retarder.

The configuration described in Additional Remark 9, in which the phase difference of π is imparted to the image light incident on the retardation film of the retarder, provides an effect of achieving the same state described above in which two types of polarized light polarized in directions perpendicular to each other when viewed along the optical axis of the image light are superimposed on each other, so that the effect of reducing the speckles produced by the image light output from the projection system can be enhanced.

Additional Remark 10: The optical module according to Additional Remark 8 or 9, further including a moving mechanism configured to move the retardation film along a direction in which the image light projected from the projection system is shifted in accordance with the phase difference and a dimension of the retardation film in a direction along the optical axis.

The configuration described in Additional Remark 10 can achieve both an appropriate phase difference imparted to the image light incident on the retardation film and an appropriate amount of shift of the image light projected from the projection system at the projection surface, reduce the speckles produced by the image light at the projection surface, and increase the resolution of an image or a video formed by the image light at the projection surface.

Additional Remark 11: The optical module according to Additional Remark 1, wherein the retarder includes a liquid crystal element.

According to the configuration described in Additional Remark 11, the phase difference imparted to the image light incident on the retarder can be readily adjusted.

Additional Remark 12: A projector including: the optical module according to Additional Remark 1 or 2; and an exterior body configured to house the optical module.

According to the configuration described in Additional Remark 12, the speckles produced by the image light projected from the projection system onto the projection surface can be further reduced, so that the speckle noise in the image light can be suppressed irrespective of whether the illuminance of the image light output from the image generation apparatus is homogenized or the polarization states of the image light are aligned with each other.

What is claimed is:

1. An optical module comprising:
a light source apparatus configured to output light;
an image generation apparatus configured to generate image light from the light output from the light source apparatus based on image information; and
a projection system configured to project light output from the image generation apparatus,
wherein the image generation apparatus includes
an image generator configured to generate the image light from the light output from the light source apparatus, and
a retarder configured to temporally change a phase difference of the image light output from the image generator.

2. The optical module according to claim 1, wherein
the retarder includes
a retardation film having a slow axis in a plane perpendicular to an optical axis of the image light output from the image generator, and
a rotator configured to rotate the retardation film around a center axis parallel to the optical axis.

3. The optical module according to claim 1, wherein
when a reference wavelength of the image light incident on the retarder is λ, a phase difference imparted to the image light incident on the retarder is π.

4. The optical module according to claim 2, wherein
a reference wavelength of the image light incident on the retarder falls within a green wavelength band and a red wavelength band in a visible wavelength band, and
an angle between an axis along a polarization direction of the image light incident on the retarder and the slow axis in a view viewed along the center axis in a plane perpendicular to the center axis corresponds to the phase difference at the reference wavelength.

5. The optical module according to claim 2, wherein
the retardation film is a waveplate configured with two quartz crystal plates bonded to each other, and
a plate surface of each of the quartz crystal plates is a surface containing a Z-axis of the quartz crystal.

6. The optical module according to claim 2, wherein
the retardation film is a stretched polymer film.

7. The optical module according to claim 2, wherein
the retardation film is a member configured with a polymer film having one surface coated with a birefringent material transparent to the image light incident on the retarder.

8. The optical module according to claim 1, wherein
the retarder includes
a retardation film having a slow axis inclining with respect to an optical axis of the image light output from the image generator in a plane containing the optical axis, and
a rotator configured to rotate the retardation film around a center axis perpendicular to the plane containing the optical axis.

9. The optical module according to claim 8, wherein
when the retardation film rotates by a predetermined maximum angle with respect to an axis perpendicular to the center axis in the plane containing the optical axis, a phase difference of π is imparted to the image light incident on the retarder.

10. The optical module according to claim 8, further comprising
a moving mechanism configured to move the retardation film along a direction in which the image light projected from the projection system is shifted in accordance with the phase difference and a dimension of the retardation film in a direction along the optical axis.

11. The optical module according to claim 1, wherein
the retarder includes a liquid crystal element.

12. A projector comprising:
the optical module according to claim 1; and
an exterior body configured to house the optical module.
